(19) United States
(12) Patent Application Publication
(10) Pub. No.: US 2021/0129577 A1
(43) Pub. Date: May 6, 2021

(54) DECORATIVE SHEET

(71) Applicant: 3M INNOVATIVE PROPERTIES COMPANY, St. Paul, MN (US)

(72) Inventors: Koji Saito, Yamagata (JP); Hidetoshi Abe, Yamagata (JP)

(21) Appl. No.: 16/474,606

(22) PCT Filed: Dec. 27, 2017
(86) PCT No.: PCT/IB2017/058421

§ 371 Date: Jun. 28, 2019

Related U.S. Application Data
(60) Provisional application No. 62/440,056, filed on Dec. 29, 2016.

(51) Int. Cl. B44C 3/02; B44C 1/10; B41M 3/06; B41M 7/00; B32B 27/08; B32B 7/12; B32B 3/30

(52) U.S. Cl. CPC B44C 3/025; B44C 1/105; B41M 3/06; B41M 7/0027; B32B 27/08; B32B 2451/00; B32B 3/30; B32B 2307/4023; B32B 2307/4026; B32B 2307/412; B32B 2307/732; B32B 7/12

(57) ABSTRACT

A decorative sheet including a base material, a three-dimensional shape printed portion provided on the base material by ultraviolet light curing inkjet printing, and an over-laminate film laminated on the base material and the printed portion, the over-laminate film including a film layer and an adhesive layer and having a three-dimensional shape following the three-dimensional shape of the printed portion.

### TECHNICAL FIELD

The present disclosure relates to a decorative sheet.

### BACKGROUND

A printed portion printed using, for example, an ultraviolet light curing inkjet printer is formed on a decorative sheet used on an advertising billboard and the like. Since the ultraviolet light curing inkjet printer is able to carry out printing of a small quantity and large variety and ink dries in a short time after printing, it is possible to greatly shorten a production period of the printed portion, or print on various media such as resin, glass, and metal.

WO/2012/073994 describes “a decorative film printed by an inkjet printer using UV ink with respect to a thin film shape base material, the decorative film being formed of a UV ink layer printed by the inkjet printer on the base material, an upper printed layer overlapping the UV ink layer and printed by gravure printing or screen printing above the UV ink layer, and a protective layer interposed between the UV ink layer and the upper printed layer”.

### SUMMARY OF INVENTION

Using ultraviolet light curing ink, it is possible to obtain a relatively thick printed layer or form a three-dimensional shape. Consequently, it is possible to form a decorative sheet having a more three-dimensional decoration by forming the printed layer using ultraviolet light curing ink. Meanwhile, it is desirable that a printed layer surface is covered by the protective layer in order to increase durability, weather resistance, or the like. Therefore, the decorative sheet is provided with the protective layer covering the printed layer surface using a simple method while maintaining a surface state with a stereoscopic effect utilizing a three-dimensional shape of the printed layer.

A decorative sheet according to an aspect of the present disclosure is provided with a base material, a three-dimensional shape printed portion provided on the base material and including ultraviolet light curing ink, and an over-laminate film laminated on the base material and the printed portion. The over-laminate film includes a film layer and an adhesive layer and has a three-dimensional shape following the three-dimensional shape of the printed portion.

A production method of the decorative sheet according to the aspect of the present disclosure, the method comprising the steps of carrying out ultraviolet light curing inkjet printing on a base material and forming a three-dimensional shape printed portion, and laminating an over-laminate film on the base material and the printed portion so that the adhesive layer of the over-laminate film faces the base material and printed portion side. Thereby, the over-laminate film is formed in a three-dimensional shape following the three-dimensional shape of the printed portion.

### BRIEF DESCRIPTION OF THE DRAWINGS

FIG. 1 is a plan view illustrating an example of a decorative sheet according to an embodiment.

FIG. 2A is an example of a decorative sheet according to a first embodiment and is a schematic cross-sectional view along line II-II in FIG. 1.

FIG. 2B is an example of a decorative sheet according to a modified example of the first embodiment and is a schematic cross-sectional view along line II-II in FIG. 1.

FIG. 3 is a diagram schematically illustrating an example of a decorative sheet production apparatus.

FIG. 4 is an example of a decorative sheet according to a second embodiment and is a schematic cross-sectional view along line II-II in FIG. 1.

FIG. 5 is an example of a decorative sheet according to a third embodiment and is a schematic cross-sectional view along line II-II in FIG. 1.

FIG. 6 is an example of a decorative sheet according to a fourth embodiment and is a schematic cross-sectional view along line II-II in FIG. 1.

FIG. 7 is a plan view illustrating an example of a decorative sheet according to a Example.

FIG. 8 is a schematic cross-sectional view along line VIII-VIII in FIG. 7.

FIG. 9 is a plan view illustrating an example of a decorative sheet according to a Example.

FIG. 10 is a schematic cross-sectional view along line X-X in FIG. 9.

### DESCRIPTION OF EMBODIMENTS

“Three-dimensional shape” in the present disclosure has a meaning of forming a stereoscopic shape. That is, has a meaning of having a difference of height with reference to a base material and the difference of height is at least 7 μm. In the “three-dimensional shape”, the printed portion having concavities and convexities on the entire surface of the base material may be provided and the difference of height is formed and the printed portion may be provided on a part of the base material and the difference of height may be formed between a region that has the printed portion and a region that does not have the printed portion.

“Followed” has the meaning of a height of the over-laminate film from the base material being changed according to change in height of the printed portions from the base material. That is, for example, when the printed portions have peaks and troughs, “followed” has the meaning of having peaks of the over-laminate film at positions of the peaks of the printed portions, and having troughs of the over-laminate film at positions of the troughs of the printed portions. Furthermore, concerning evaluation of whether or not the over-laminate film has the three-dimensional shape following the three-dimensional shape of the printed portion, evaluation of “has the three-dimensional shape following” is possible, for example, in a case where it is possible to recognize the three-dimensional shape of the printed portion through the over-laminate film or a case where the three-dimensional shape of the over-laminate film is recognized as substantially the same shape as the three-dimensional shape of the printed portion or a shape that is similar thereto. Evaluation of “has the three-dimensional shape following” is possible, for example, in a case where the number of peaks that are recognized as the three-dimensional shape of the over-laminate film with respect to the number of peaks that are recognized as the three-dimensional shape of the printed portion.

“Transparent” has a meaning of average transmittance of light in a visible range of approximately 60% or greater, preferably approximately 80% or greater, and more preferably approximately 90% or greater, and is not limited to being colorless and transparent, semitransparent is also included. “Colored” has a meaning of achromatic color or chromatic color. In addition, not limited to a single color, a form having a pattern formed of a plurality of colors is also included, and furthermore, semitransparent is also included.

“Printed portion” is a part including a single printed layer or a plurality of printed layers, single “printed layer” is a layer formed by the same ultraviolet light curing ink, and in a case where the plurality of layers formed from the same type of ultraviolet light curing ink with different pigments are present, the printed layers are different from each other. That is, in a case where, for example, the printed layer is formed by an inkjet printer, the printed layer formed by landing ultraviolet light curing ink of the same color a plurality of times at the same position is a single layer.

“Planar pattern” has a meaning of a shape and size of the printed layer in planar view of the printed layer. “Substantially the same planar pattern” is a case of having the same shape and size of the printed layer, or even if different, as long as it is not possible to recognize a difference with the naked eye, substantially the same pattern is presumed. “Different planar pattern” has a meaning of the shape and size of the printed layer being different and is outside of “substantially the same planar pattern”.

Decorative Sheet

A decorative sheet according to an aspect of the present disclosure is provided with a base material, a three-dimensional shape printed portion provided on the base material and including ultraviolet light curing ink, and an over-laminate film laminated on the base material and the printed portion. The over-laminate film has a film layer on the surface side and an adhesive layer on the rear side, and has a three-dimensional shape following the three-dimensional shape of the printed portion by laminating on the printed portion via the adhesive layer. The printed portion includes, for example, a printed layer formed by inkjet printing.

Since the decorative sheet according to the aspect is provided with the over-laminate film having the three-dimensional shape following the three-dimensional shape of the printed portion, it is possible to provide decoration with the stereoscopic effect in comparison to the decorative sheet with a two-dimensional shape with the surface flattened. Since the over-laminate film is a film with an adhesive, it is possible to easily cover the printed portion, and it is possible to protect the printed portion and improve durability and weather resistance.

In the decorative sheet according to the aspect, a thickness of at least one part of a printed portion may be approximately 7 μm or greater. In the decorative sheet according to the aspect, a thickness of at least one part of a printed portion may be approximately 15 μm or greater. In the decorative sheet according to the aspect, a thickness of at least one part of a printed portion may be approximately 20 μm or greater. It is possible to carry out decoration with the stereoscopic effect by setting the thickness of such printed portions to a fixed amount or greater.

As will be described later, the film layer of the over-laminate film is able to be set as a thermoplastic resin film with the thickness of a fixed amount or less provided with pliability following the three-dimensional shape of the printed portion when the printed portion is covered. A specific example of a thermoplastic film will be described later.

In the decorative sheet according to the aspect, it is preferable that the thickness of the film layer of the over-laminate film is approximately 90 μm or less. Followability is easily obtained in the three-dimensional shape of the printed portion by adjusting the thickness of such a film layer. In the decorative sheet according to the aspect, the thickness of the film layer of the over-laminate film may be approximately 60 μm or less or 50 μm or less. In the decorative sheet according to the aspect, since the film layer functions as the protective layer, it is preferable that the thickness of the film layer is approximately 5 μm or greater, and may be approximately 10 μm or greater.

In the decorative sheet according to the aspect, when the surface roughness of the over-laminate film before being laminated on the base material and the printed portion is set as Ra (0) and the surface roughness of the over-laminate film laminated on the base material and the printed portion is set as Ra, it is preferable that a surface roughness change ratio Ra (ratio) of the over-laminate film represented by Formula (1) is set to approximately 110% or greater.

Ra(ratio)(%)=(Ra−Ra(0))/Ra(0)×100. Formula 1:

A numeric value of the change ratio Ra is one index indicating the degree of following by the over-laminate film on the concavities and convexities of the printed portion and the greater the numeric value, the greater the decoration with the stereoscopic effect is obtained.

In the decorative sheet according to the aspect, the surface roughness Rz of the over-laminate film may be approximately 10 μm or greater. In the decorative sheet according to the aspect, the surface roughness Rz of an overlay film may be approximately 15 μm or greater. In the decorative sheet according to the aspect, the surface roughness Rz of the over-laminate film may be approximately 20 μm or greater. The surface roughness Rz of the over-laminate film is one index indicating the degree of following by the over-laminate film on the concavities and convexities of the printed portion and the greater the numeric value, the greater the decoration with the stereoscopic effect is obtained.

In the decorative sheet according to the aspect, the film layer of the over-laminate film may be transparent. In the decorative sheet according to the aspect, the film layer of the over-laminate film may be colored.

In the decorative sheet according to the aspect, it is desirable that the peak temperature of a coefficient of loss (tan δ) of the adhesive layer of the over-laminate film is −20° C. or higher. In this case, since shape maintenance of the adhesive layer is great, after covering it is also possible to maintain the three-dimensional shape of the over-laminate film covering to follow the three-dimensional shape of the printed portion. As a result, it is possible to more stably maintain the sterical decoration of the decorative sheet surface. In the decorative sheet according to the aspect, the peak temperature of the tan δ of the adhesive layer may be approximately −15° C. or higher or approximately −10° C. or higher. In the decorative sheet according to the aspect, it is desirable that the peak temperature of the tan δ of the adhesive layer is approximately 5° C. or lower. In this condition, it is possible to exhibit adhesiveness with good efficiency at room temperature. In the decorative sheet according to the aspect, the peak temperature of the tan δ of the adhesive layer may be approximately 0° C. or lower.

In the decorative sheet according to the aspect, the printed portion may have a plurality of printed layers. In the decorative sheet according to the aspect, the plurality of printed layers may include a first printed layer and a second printed layer that has substantially the same planar pattern as the first printed layer and is disposed on the first printed layer. It is possible to provide a more sterical decoration.

In the decorative sheet according to the aspect, the plurality of printed layers may include at least a color layer with low transparency and a stereoscopic form layer with higher transparency than the transparency of the color layer.

In the decorative sheet according to the aspect, the plurality of printed layers may include a first printed layer and a second printed layer that has a different planar pattern from the first printed layer and is disposed on the first printed layer. It is possible to provide a more complex and colorful decoration.

In the decorative sheet according to the aspect, there may further be a surface-protecting layer on the outermost surface of the over-laminate film.

A production method of the decorative sheet according to the aspect of the present disclosure, the method comprising the steps of carrying out ultraviolet light curing inkjet printing on a base material and forming a three-dimensional shape printed portion, and laminating an over-laminate film on the base material and the printed portion so that the adhesive layer of the over-laminate film faces the base material and printed portion side. Thereby, the over-laminate film is formed in a three-dimensional shape following the three-dimensional shape of the printed portion.

In the production method of the decorative sheet according to the aspect, during lamination, the over-laminate film may be heated to room temperature or higher. In a case where the over-laminate film is a thermoplastic film, it is possible to further increase followability with respect to the three-dimensional shape of the printed portion. The heat temperature may be approximately 35° C. or higher or approximately 50° C. or higher. Meanwhile, the heat temperature may be approximately 85° C. or lower such that the three-dimensional shape of the printed layer is maintained.

Hereinafter, the base material, the printed portion, the over-laminate film, and the surface-protecting layer of the decorative sheet according to the present disclosure will be described in further detail.

<Substrate>

For example, the base material is provided with a graphic film, the adhesive layer, and a release liner. The graphic film is provided on the adhesive layer, and the adhesive layer is provided on the release liner.

For example, the graphic film includes polyurethane, acrylic resin, polyester, polyolefin, vinyl chloride resin, vinyl chloride-vinyl acetate resin, polycarbonate, polyimide, polyamide, and polyester-amide. For example, a graphic film 11 may include vinyl chloride resin, vinyl chloride-vinyl acetate resin, acrylic resin, and a combination thereof, and may be a laminated body of a plurality of materials. Since the graphic film including the materials is superior in reception of ink, the high quality printed portion is formed on the graphic film.

For example, the adhesive layer includes a thermoplastic material, and specifically, includes a material such as acrylic adhesive, polyester adhesive, rubber adhesive, silicone adhesive, or polyurethane adhesive.

The release liner may be a liner often used in fields of adhesive tapes and the like, and is not limited to the specific members. Preferred release liners include paper, plastic materials such as polyethylene, polypropylene, polyesters or cellulose acetate, paper or another material that is covered or laminated with this type of plastic material. The release liner may be used without further modification, but can be used after being subjected to silicone treatment or treated using another method in order to improve the release properties thereof.

It is possible to use various commercially available products as the base material and it is possible to use a commercially available film such as a graphic film appropriate for formation of a printed image. Scotchcal™ graphic film IJ180-10, Scotchcal™ graphic film IJ5331, and Scotchcal™ graphic film IJ8150 (the above manufactured by 3M) are given as examples of commercially available graphic films. The Scotchcal™ graphic films are provided with the graphic film, the adhesive layer, and the release liner. The thickness of the combined graphic film and adhesive layer may be set as, for example, approximately 80 μm to approximately 90 μm. The thickness of the release liner may be set as, for example, approximately 10 μm to approximately 500 μm.

<Printed Portion>

The printed portion includes ultraviolet light curing ink and is formed by ultraviolet light curing inkjet printing. Ultraviolet light curing inkjet printing is able to easily print the printed image on the base material even in a small lot unit on the basis of the printed image data corresponding to various images and it is possible to obtain a full color printed image having outdoor weather resistance. The ultraviolet light curing ink used in ultraviolet light curing inkjet printing is provided with, for example, a photopolymerizable resin, a photopolymerization initiator, a coloring agent, and an adjuvant. Full color printing is possible by the ultraviolet light curing ink generally being provided as four colors of ink sets of cyan (C) ink, magenta (M) ink, yellow (Y) ink, and black (K) ink. As examples, ultraviolet light curing ink LUS-200 (manufactured by 3M) and UJV500-160 UV inkjet printer pure ink (manufactured by Mimaki Engineering Co., Ltd.) are given as the ultraviolet light curing ink. It is also possible to use transparent ink as the ultraviolet light curing ink. For example, it is possible to use UV curing ink for an inkjet printer manufactured by Fujifilm Corporation (product name: UV-IJINK LL391 CLEAR 600 ml) as such an ink.

A region in which the printed portion is formed on the base material is a printed region. In a case where inkjet printing is performed, it is possible to set a maximum thickness of the printed portion to approximately 7 μm in printing of one time, that is, landing ink one time. In a case where overlapping printing is performed, it is possible to form a part in which the thickness in the printed portion exceeds approximately 7 μm.

The printed portion has a three-dimensional shape, and in particular, has a thickness in a height direction with reference to the base material. For example, in a case where the printed region and a peripheral region outside of the printing region are formed on the base material, the printed region has difference of height with respect to the peripheral region and forms a sterical three-dimensional shape. If peaks and troughs are formed on the surface of the printed portion, the printed portion itself has difference of height and forms the sterical three-dimensional shape.

The printed portion may include a plurality of printed layers. For example, the printed portions may include the first printed layer and the second printed layer having substantially the same planar pattern as the first printed layer and disposed on the first printed layer. The printed portions may include the first printed layer and the second printed layer having a planar pattern different from the first printed layer and disposed on the first printed layer. The plurality of printed layers are not limited to a case including two layers, that is, the first printed layer and the second printed layer, and may be provided with three layers or more.

The plurality of printed layers may include at least a color layer with low transparency and a stereoscopic form layer with higher transparency than the transparency of the color layer. For example, the first printed layer may be the color layer and the second printed layer may be the stereoscopic form layer. In the case of three layers or more, two stereoscopic form layers may be provided to interpose the color layer.

<Over-Laminate Film>

The over-laminate film is provided with the film layer and an adhesive layer, and is laminated on the printed portion via the adhesive layer. When the over-laminate film is bonded to the printed layer, the film layer indicates good efficiency of followability with respect to the three-dimensional shape of the printed layer, and is able to maintain a flow state of the over-laminate film with good efficiency due to adhesiveness of the adhesive layer after bonding.

The film layer is able to be a film in which the thermoplastic resin is a base following the three-dimensional shape of the printed portion when heated at a temperature of room temperature or higher. The film layer is able to be a film in which the thermoplastic resin is the base following the three-dimensional shape of the printed portion when heated at a temperature of approximately 35° C. or higher and approximately 80° C. or lower. For example, it is possible to use the film layer in which thermoplastic resin such as polyvinyl chloride, polyacrylic resin, polyfluorine resin, polyurethane resin, or ABS resin is the base.

The thickness of the film layer is preferably approximately 90 μm or less, and may be 60 μm or less or approximately 50 μm or less such that followability with respect to the three-dimensional shape of the printed portion is not interfered with. Since the thickness of the film layer functions as the protective layer, it is preferable that the thickness of the film layer is approximately 5 μm or greater and may be approximately 10 μm or greater.

In an embodiment, a glass transition temperature of the resin included in the film layer is approximately 90° C. or lower, approximately 85° C. or lower, or approximately 80° C. or lower. Due to the glass transition temperature of the resin being approximately 90° C. or lower, it is possible to further improve the surface followability of a decorative adhesive film. Meanwhile, the glass transition temperature of the film layer is desirably approximately 30° C. or higher, approximately 35° C. or higher, or approximately 40° C. or higher. Due to the glass transition temperature of the film layer being approximately 30° C. or higher, it is possible to reduce tackiness of the film layer, more effectively prevent adherence of dust, and increase blocking resistance.

In a case where the film layer is a polyvinyl chloride resin, the film layer may include only polyvinyl chloride as a polymer component, and may include additional polymers such as thermoplastic polyurethane, acrylonitrile-butadiene rubber (NBR), acrylonitrile-butadiene-styrene (ABS) copolymers, ethylene-vinyl acetate (EVA) copolymers, and acrylic resin in an amount such as approximately 40 mass % or less, approximately 30 mass % or less, or approximately 20 mass % or less with a purpose in which a characteristic such as impact resistance is modified. The polyvinyl chloride resin may include another additive such as a plasticizer such as phthalic acid ester, adipic acid ester, and trimellitic acid ester, an antioxidant, an ultraviolet absorber, a thermal stabilizer, and a pigment. In an embodiment, the film layer includes polyvinyl chloride resin and plasticizers, and the amount of plasticizer is approximately 20 parts by mass or greater or approximately 25 parts by mass or greater, and approximately 40 parts by mass or less or approximately 35 parts by mass or less with respect to 100 parts by mass of polyvinyl chloride resin. In this case, the film layer is able to indicate good efficiency of followability with respect to the three-dimensional printed layer.

In a case where the film layer is polyurethane resin, the film layer is able to include a resin obtained by polymerizing polyol and a crosslinking agent. As the polyol, it is possible to use, for example, acrylic polyols, polyurethane polyols, polyester polyols such as polycaprolactonediol, polycarbonate polyols, polyether polyols such as polyethylene glycol and polypropylene glycol, and the like. In an embodiment, the film layer includes polyurethane resin that has units derived from polyols of at least one selected from polyurethane polyols, polyester polyols, and polycarbonate polyols. As the crosslinking agent, it is possible to use aliphatic polyisocyanates such as hexamethylene diisocyanate, alicyclic polyisocyanates such as isophorone diisocyanate, hydrogenated diphenylmethane diisocyanate, aromatic polyisocyanates such as tolylene diisocyanate, diphenylmethane diisocyanate, xylylene diisocyanate, methylene bis (4-phenylisocyanate), burettes, isocyanurates, or adducts thereof, polycarbodiimide, and the like. In an embodiment, the polyurethane resin has units derived from a non-yellowing polyisocyanate. Examples of the non-yellowing polyisocyanate include hexamethylene diisocyanate, isophorone diisocyanate, hydrogenated diphenylmethane diisocyanate, and the like. According to the embodiment, it is possible to obtain the decorative adhesive film particularly superior in weather resistance. For superior durability and weather resistance, it is possible to advantageously use acrylic urethane resin that is a polymerization adduct of acrylic polyol and the crosslinking agent.

In a case where the film layer includes acrylic resin, it is possible for the film layer to include a polymer blend of carboxyl group-containing (meth)acrylic polymer and amino group-containing (meth)acrylic polymer. The acrylic resin film including such a polymer blend has high tensile strength and superior elongation properties, and therefore it is possible to provide the decorative film having favorable followability with respect to the surface having the three-dimensional shape. As necessary, it is also possible to form the polymer blend by mixing carboxyl group-containing (meth)acrylic polymer of one type or two or more types and an amino group-containing (meth)acrylic polymer of one type or two or more types. In a case where the film layer includes acrylic resin, the film layer has superior weather resistance and the like and is particularly appropriate in application exposed to a harsh external environment.

In a case where the film layer includes fluororesin, the film layer is able to include a polymer obtained by polymerizing a fluorine monomer. The fluorine monomer is, for example, a fluorine ethylene monomer such as vinylidene fluoride, hexafluoropropylene, tetrafluoroethylene, and trifluoride ethylene chloride. In addition to the fluorine monomer, one type or two or more types of copolymerizable monomers may be mixed such as methacrylate such as methyl methacrylate, ethyl methacrylate, propyl methacrylate, and acrylate such as butyl methacrylate, methyl acrylate, ethyl acrylate, propyl acrylate, and butyl acrylate. A fluororesin composition may be used in which fluororesin and acrylic resin are blended. For example, in the acrylic polyol resin, the hydroxyl group of the polyol and the hydroxyl group within the (meth)acrylic polymer each react with an isocyanate crosslinking agent, and thereby, the acrylic polyol resin is formed due to urethane bonding. In a case where the film layer includes fluororesin, the film layer has superior chemical resistance, weather resistance, and the like and it is particularly appropriate in application exposed to a harsh external environment.

In an embodiment, it is also possible to use a film layer including a polymer formulation including thermoplastic polyurethane and cellulosic ester described in WO/2013/019699 (title: “Graphic Article”, Inventor: Steelman et al.) and WO/2013/019706 (title: “Graphic Article”, Inventor: Steelman et al.) or a film layer including a polymer formulation including thermoplastic polyurethane and polyvinyl butyral described in WO/2014/123766 (title: “Graphic Article”, Inventor: Steelman et al.).

In an embodiment, the film may have a multilayer film structure. In the multilayer film structure, each film layer may be a different material, may be a different additive using the same material, or may be a compounded ratio using the same material. For example, it is possible to form the multilayer film structure using the first film layer formed from one material of the thermoplastic resin described above and the second film layer formed from a thermoplastic resin other than the first film layer. Alternatively, the multilayer film structure may include a pigment in one film layer. Specifically, the film may include a transparent layer on a white layer, or may include the white layer on another pigment color.

The film layer can be transparent, and can be colored. A case where the adhesive layer is transparent and the film layer is transparent has the meaning of a substantially transparent over-laminate film. A case where the film layer is colored has the meaning of the colored over-laminate film. For example, if the over-laminate film is transparent (including semitransparent), characters or diagrams configured by the printed portion are visually recognized through the over-laminate film.

It is possible to use a film formed by various forming methods such as an extruded film, an extruded stretched film, a calendar film, and a cast film or a laminate thereof as the film layer. In an embodiment, the film layer is able to be a cast film. According to a cast method, it is easy to obtain a thin film layer and residual internal stress is relatively low, and therefore surface followability of the decorative adhesive film can be advantageously increased. Other than various coating methods using a solvent of a bar coating and a knife coating, a film produced using a hot melt coating method not using the solvent is included on the cast film.

According to the application of the decorative adhesive film, it is also possible to add a conventionally known additive such as an antioxidant, a UV absorbing agent, a light stabilizer, a plasticizer, a lubricant, an antistatic agent, a flame retardant, and a filler to the film layer.

For example, the adhesive layer includes a thermoplastic material, and specifically, for example, includes acrylic adhesive, polyester adhesive, rubber adhesive, silicone adhesive, or polyurethane adhesive.

In the adhesive layer, the peak temperature of the coefficient of loss (tan δ) due to a dynamic viscoelasticity measurement method is preferably approximately −20° C. or higher and more preferably approximately −10° C. or higher. When the peak temperature is low, after the adhesive layer is heat deformed, it is considered that sufficient followability to easily return to the original shape is not obtained. The thickness of the adhesive layer may be, for example, approximately 5 μm to approximately 50 μm. For example, white pigment or black pigment may be added to the adhesive layer.

The adhesive forming the adhesive layer may contain, for example, a tacky adhesive polymer or the crosslinking agent. An added quantity of the crosslinking agent is able to be appropriately adjusted according to the type of tacky adhesive polymer or the crosslinking agent, but for example, may be 0.02 to 2 parts by mass and may be 0.003 to 1 part by mass with respect to 100 parts by mass of the tacky adhesive polymer. As the crosslinking agent, it is possible to use, for example, an isocyanate compound, a melamine compound, a poly(meth)acrylate compound, an epoxy compound, an amide compound, and a bisamide compound. Furthermore, it is possible to add a monomer composition as the adhesive. The adhesive may further contain an additive such as a tackifier and the UV absorbing agent.

The coefficient of loss tan δ (=shear loss elastic modulus G″/shear storage elastic modulus G′) of the adhesive layer is measured using an ARES dynamic viscoelasticity measuring device (manufactured by T.A. Instruments Japan, Shinagawa-ku, Tokyo, Japan). Measurement conditions include drying thickness of the adhesive of 1 to 3 mm, a diameter of the adhesive of approximately 7.9 mm, raised temperature range of −60° C. to 100° C., rate of temperature rise 5.0° C./second, and a shear mode of frequency of 1.0 Hz, and under these conditions, the shear storage elastic modulus G′ and the shear loss elastic modulus G″ are measured. The peak temperature of the coefficient of loss tan δ is preferably approximately −20° C. to approximately 5° C., and more preferably approximately −18° C. to approximately 0° C.

In a case where the peak temperature of the coefficient of loss tan δ is approximately −20° C. or higher, since shape maintenance of the adhesive layer is high, after covering, it is also possible to maintain the three-dimensional shape of the over-laminate film covering to follow the three-dimensional shape of the printed portion. As a result, it is possible to more stably maintain the sterical decoration of the decorative sheet surface.

In an embodiment, the thickness of the adhesive layer may be approximately 0.5 times or approximately 2 times the thickness of the film layer. The thickness of the adhesive layer may be approximately 5 μm or greater, 10 μm or greater, or 20 μm or greater. Meanwhile, the thickness of adhesive layer may be 80 μm or less, 50 μm or less, or 40 μm or less. In an embodiment, it is possible for the thickness of the adhesive layer to be approximately 0.5 times or greater or approximately 1 time or greater of the thickness of the film layer. The higher a ratio of thickness of the adhesive layer with respect to the film layer, the greater the influence of physical properties of the over-laminate film, for example, physical properties of the adhesive layer such as tensile strength and extension percentage, and as a result, the more it is possible to increase surface followability of the over-laminate film. The thicker the adhesive layer, the greater the effect of alleviation of stress on the film layer occurring when boding to an adherend having an uneven surface. It is possible to give followability with respect to the three-dimensional shape of the printed portion by setting the over-laminate film bonded to a relatively thick adhesive layer with regard to such a film layer. In an embodiment, the thickness of the adhesive layer may be approximately 0.5 times to approximately 2 times the thickness of the film layer.

It is preferable that the over-laminate film has pliability in order to exhibit favorable followability of the over-laminate film with respect to the three-dimensional shape of the printed portion. It is also possible to express pliability of the over-laminate film by tensile strength or the extension percentage during film rupture.

In an embodiment, tensile strength during 5% extension of the over-laminate film may be approximately 14 MPa or less, approximately 12 MPa or less, or approximately 11 MPa or less when measured under conditions of temperature of 20° C., initial grasp interval of 100 mm, and tensile rate of 300 mm/minute pursuant to JIS K 6251. Under the heating conditions during lamination on the printed portion of the over-laminate film, the over-laminate film provides more favorable followability with regard to the three-dimensional shape of the printed portion, and after bonding, is able to favorably maintain the three-dimensional shape following thereto.

In an embodiment, the extension percentage during rupture of the over-laminate film is approximately 100% or greater, approximately 120% or greater, or approximately 150% or greater when measured under conditions of temperature of 20° C., initial grasp interval of 100 mm, and tensile rate of 300 mm/minute pursuant to JIS K 6251. It is possible to obtain the extension percentage from Formula (2) below by measuring an inter-bench mark distance L1 (mm) when the measured test sample is cut, and using the initial grasp interval of 100 mm.

Extension percentage(%) during rupture=[(L1−100)/100]×100. Formula 2:

It is possible for the over-laminate film to include the release liner. Release liners include paper, plastic materials such as polyethylene, polypropylene, polyesters, or cellulose acetate, or paper that is covered or laminated with this type of plastic material. A method such as silicone treatment may be executed on the release liner. The thickness of the release liner is set as, for example, approximately 10 μm to approximately 500 μm.

An example of the thickness of the film layer of the over-laminate film is approximately 90 μm or less. Another example of the thickness of the film layer of the over-laminate film is approximately 60 μm or less. Specifically, in a case where the over-laminate film is polyvinyl chloride resin, in a case where the thickness of the film layer is approximately 90 μm or less, and in a case where the concavities and convexities of the printed portion is approximately 7 μm or greater, the over-laminate film is able to obtain favorable followability. In a case where the over-laminate film is the acrylic resin, in a case where the thickness of the film layer is 50 μm or less, and in a case where the concavities and convexities of the printed portion is approximately 7 μm or greater, the over-laminate film is able to obtain favorable followability.

Due to the thickness of the film layer of the over-laminate film becoming thinner, it is easy to maintain the stereoscopic effect in the characters or diagrams configured by the printed portion. However, when the thickness of the film layer is approximately less than 10 μm, since the elasticity of the over-laminate film, that is, the modulus of elasticity is reduced and a function of a support is not satisfied, there may be interferences in various manufacturing processes. When the thickness of the film layer exceeds approximately 90 μm, plastic deformation may tend not to occur.

The over-laminate film has the three-dimensional shape following the three-dimensional shape of the printed portion (printed region). Accordingly, for example, the height of the over-laminate film from the surface of the base material on the printed region is higher in comparison to the height of the over-laminate film from the surface of the base material in the peripheral region. For example, the surface roughness Rz of the over-laminate film laminated on the base material and the printed portion is approximately 10 μm or greater.

When the surface roughness of the over-laminate film before being laminated on the base material and the printed portion is set as Ra (0) and the surface roughness of the over-laminate film laminated on the base material and the printed portion is set as Ra, the surface roughness change ratio Ra (ratio) of the over-laminate film represented by Formula (1) is set to, for example, approximately 110% or greater. Approximately 200% or greater or approximately 400% or greater are also acceptable.

As described above, the printed portion has the three-dimensional shape. That is, the more the surface roughness Ra of the over-laminate film is increased in comparison to the surface roughness Ra (0) of the over-laminate film, the more the stereoscopic effect of the over-laminate film stands out according to the three-dimensional shape of the printed portion. In particular, if the surface roughness change ratio Ra (ratio) of the over-laminate film is 110% or greater, it is easy to provide decoration with the stereoscopic effect according to the three-dimensional shape of the printed portion.

Surface-Protecting Layer

It is possible to provide the decorative sheet with the surface-protecting layer as necessary. The surface-protecting layer includes, for example, thermoplastic resin, and specifically, includes, for example, polyacrylic resin, polyfluorine resin, or polyvinyl chloride resin. As necessary, the surface-protecting layer may include a curing agent or another additive. The thickness of the surface-protecting layer may be, for example, approximately 1 μm or greater or approximately 2 μm or greater. Meanwhile, the thickness of the surface-protecting layer may be approximately 10 μm or less or approximately 5 μm or less.

Decorative Sheet Production Method

A production method of the decorative sheet comprises, for example, the steps of carrying out ultraviolet light curing inkjet printing on a base material and forming a three-dimensional shape printed portion, and laminating an over-laminate film on the base material and the printed portion so that the adhesive layer of the over-laminate film faces the base material and printed portion side. During lamination of the present production method, the over-laminate film is formed in a three-dimensional shape covering to follow the three-dimensional shape of the printed portion.

Over-Laminate Film Production Method

Commercially available thermoplastic film can be used for the film layer configured by the over-laminate film, but for example, it is possible to produce a film with good followability with respect to the three-dimensional shape of the printed portion in the following production method. A polyester film on which peeling treatment is carried out on the surface, for example, a polyethylene terephthalate (PET) film, is prepared. A solution, in which a thermoplastic resin usable as the film layer described above is dissolved in a solvent, is coated using a knife coater and the like on a peeling treated PET surface and the film layer is formed at a desired thickness by drying. By using such a coating method, it is possible to form the film layer with favorable followability of the three-dimensional shape of the printed portion with a thickness of approximately 100 μm or approximately 50 μm or less.

During lamination of the present production method, the over-laminate film is laminated in a state of being heated to approximately 35° C. or higher and approximately 85° C. or lower. Unwinding and winding speed of the base material, that is, laminating speed of the base material is, for example, approximately 30 cm per minute to approximately 60 cm per minute. It is possible to carry out production of the decorative sheet using, for example, a decorative sheet production apparatus.

A plurality of aspects of the decorative sheet according to the embodiments will be described in detail below with reference to the drawings.

### First Embodiment

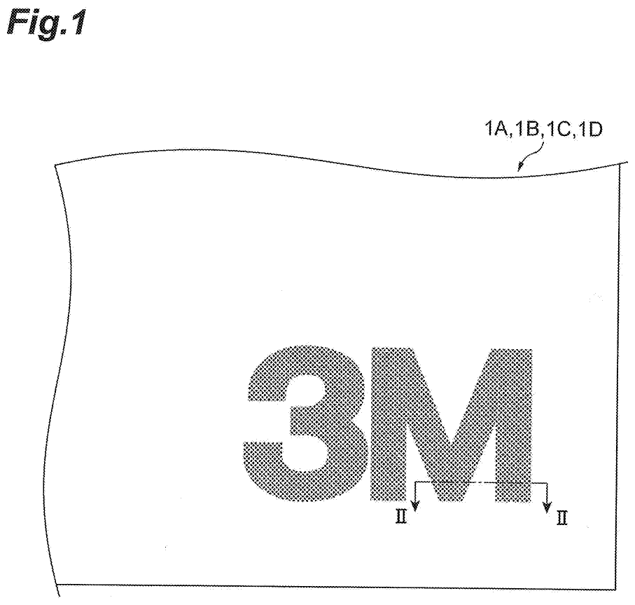

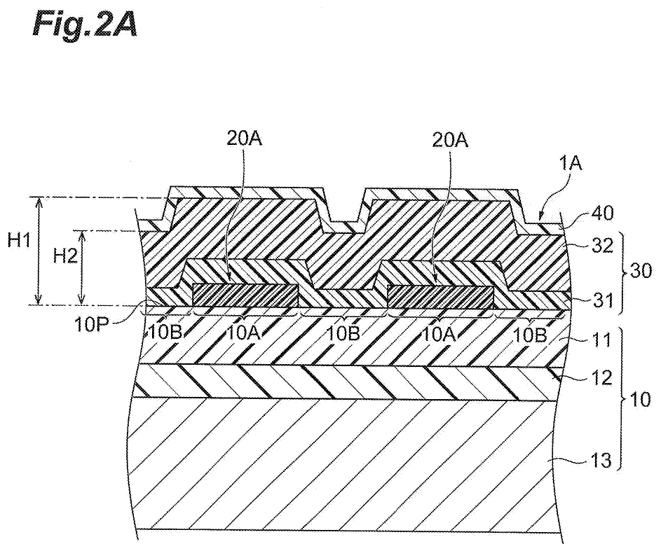

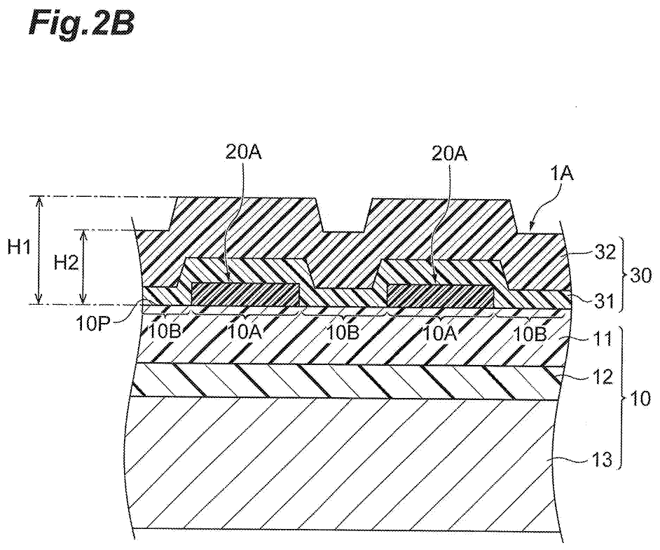

FIG. 1 is an example of a planar view illustrating each form of the decorative sheet together. FIG. 2A is an example of a decorative sheet according to a first embodiment and is a schematic cross-sectional view along line II-II in FIG. 1. In FIG. 2A, for ease of visibility, dimensions in a thickness direction with respect to dimensions in a width direction are indicated so as to be thicker than in the actual form.

A decorative sheet 1A is provided with a base material 10, printed portions 20A provided on the base material 10, and an over-laminate film 30 provided on the base material 10 and the printed portions 20A. The base material 10 is provided with a graphic film 11, an adhesive layer 12, and a release liner 13.

The over-laminate film 30 includes a film layer 32 and a tacky adhesive layer 31. The tacky adhesive layer 31 adheres the film layer 32 and the base material 10, and the film layer 32 and the printed portion 20A. As necessary, the decorative sheet 1A may have a surface-protecting layer 40 on the outermost surface of the over-laminate film 30, and it is also possible to omit the surface-protecting layer 40. For example, FIG. 2B is a cross-sectional view of the decorative sheet 1A according to a modified example, and the surface-protecting layer 40 is omitted.

A printed region 10A in which the printed portion 20A is provided and a peripheral region 10B outside of the printed region 10A are provided on the base material 10. The printed portion 20A includes ultraviolet light curing ink and is formed by ultraviolet light curing inkjet printing. The printed portion 20A has, for example, the three-dimensional shape, and the over-laminate film 30 has the three-dimensional shape following the three-dimensional shape of the printed portion 20A. Height H1 of the over-laminate film 30 from a surface 10P of the base material 10 on the printed region 10A is higher in comparison to a height H2 of the over-laminate film 30 from the surface 10P of the base material 10 in the peripheral region 10B. For example, the surface roughness Rz of the over-laminate film 30 laminated on the base material 10 and the printed portion 20A is approximately 10 μm or greater.

Decorative Sheet Production Method

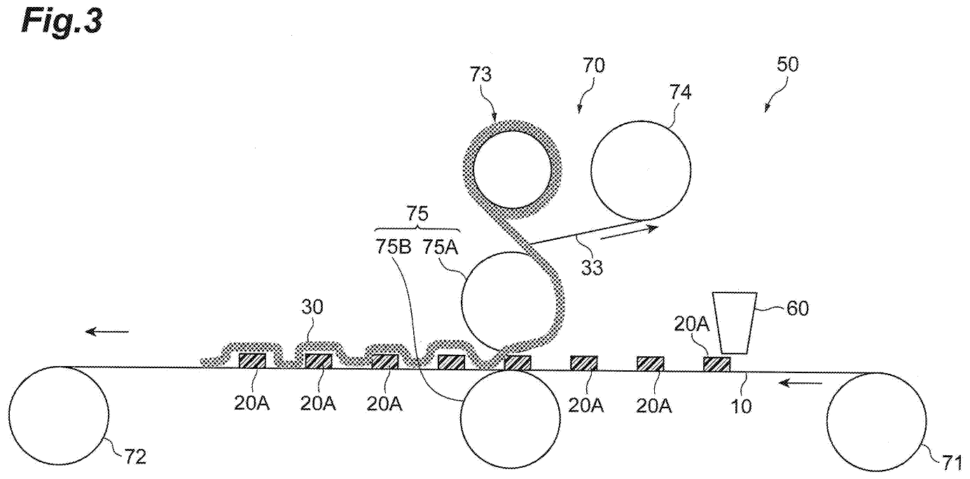

Next, description will be given of an example of a production method of the decorative sheet 1A. FIG. 3 is a diagram schematically illustrating an example of the decorative sheet production apparatus. For example, a decorative sheet production apparatus 50 is provided with an inkjet printing device 60 for forming the printed portion 20A on the base material 10 and a laminating device 70 for providing the over-laminate film 30 on the base material 10.

The inkjet printing device 60 is an ultraviolet light curing inkjet printing device. Specifically, it is possible to use inkjet printer UJF-3042FX (manufactured by Mimaki Engineering Co., Ltd.) as the ultraviolet light curing inkjet printing device.

The laminating device 70 is a roll to roll application device. Specifically, it is possible to use a laminator AE-1600 (manufactured by ACCO brands Japan) as the roll to roll application device. For example, the roll to roll application device has a base material unwinding roll 71 performing unwinding of the base material 10, a base material winding roll 72 performing winding of the base material 10, an over-laminate film unwinding roll 73 performing unwinding of the over-laminate film 30, a release liner winding roll 74 performing winding of the release liner 13 of the over-laminate film 30, and two nip rollers 75 for applying the over-laminate film 30 on the base material 10, that is, a first nip roller 75A and a second nip roller 75B.

Initially, the decorative sheet production apparatus 50 unwinds the base material 10 from the base material unwinding roll 71, and the inkjet printing device 60 forms the printed portion 20A by carrying out inkjet printing followed by an ultraviolet light irradiation process (printing process). Next, the laminating device 70 unwinds the over-laminate film 30 from the over-laminate film unwinding roll 73, and laminates the over-laminate film 30 to be bonded using the nip roller 75 with respect to the base material 10 on which the printed portion 20A is formed (lamination process). The release liner 33 of the over-laminate film 30 is peeled prior to bonding to the base material 10 using the nip roller 75. The peeled release liner 33 is wound by the release liner winding roll 74. The decorative sheet production apparatus 50 winds the base material 10 to which the over-laminate film 30 is bonded using the base material winding roll 72.

In the lamination step, the over-laminate film is laminated in a state of being heated. Specifically, out of the nip rollers 75, as necessary, the first nip roller 75A contacting the over-laminate film 30 is heated in a temperature range of, for example, approximately 35° C. to approximately 85° C. When the first nip roller 75A is heated in the temperature range, flexibility of the over-laminate film 30 is improved, and the three-dimensional shape tends to be formed following the three-dimensional shape of the printed portion 20A. Unwinding and winding speed of the base material 10, that is, laminating speed is, for example, approximately 30 cm per minute to approximately 60 cm per minute.

### Second Embodiment

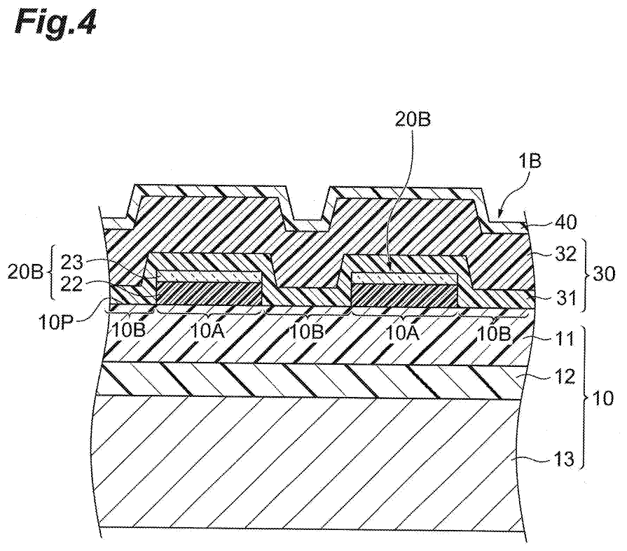

FIG. 4 is an example of a decorative sheet according to a second embodiment and is a schematic cross-sectional view along line II-II in FIG. 2. In FIG. 4, for ease of visibility, dimensions in the thickness direction with respect to dimensions in the width direction are indicated so as to be thicker than in the actual form. A decorative sheet 1B according to the second embodiment is provided with the same elements and structure as the decorative sheet 1A of the first embodiment. Accordingly, the following description is made focusing on different parts, common elements and structure are given the same reference numerals, and detailed description is omitted.

The decorative sheet 1B according to the second embodiment is provided with the base material 10, a printed portion 20B provided on the base material 10, the over-laminate film 30 provided on the base material 10 and the printed portion 20B, and as necessary, the surface-protecting layer 40. Differently from the printed portion 20A of the decorative sheet 1A, the printed portion 20B is provided with a plurality of printed layers.

For example, the plurality of printed layers include a first printed layer 22 and a second printed layer 23. The second printed layer 23 has substantially the same planar pattern as the first printed layer 22 and is disposed on the first printed layer 22. In the plurality of printed layers 22 and 23 of the decorative sheet 1B, each printed layer 22 and 23 has substantially the same planar pattern as each other. In the present disclosure, “synchronous” has the meaning of each printed layer 22 and 23 having substantially the same planar pattern as each other. By synchronizing each printed layer 22 and 23, the three-dimensional shape of the printed portion 20B is prominent, and in particular, the shape in the height direction from the base material 10 is further emphasized.

In the present embodiment, the first printed layer 22 includes colored ultraviolet light curing ink, and is a colored printed layer. With respect to the first printed layer 22, the second printed layer 23 includes a transparent ultraviolet light curing ink. The first printed layer 22 is a layer in which transparency is lower in comparison to at least the second printed layer 23 and prioritizes a color function independently imparting influence on color or pattern of the printed portion 20B, and is an example of the color layer. The second printed layer 23 has a higher transparency than at least the transparency of the first printed layer 22. The second printed layer 23 is a layer in which the thickness of the printed portion 20B is thickened such that the three-dimensional shape is prominent, and is a layer prioritizing a three-dimensional shape function. The second printed layer 23 is an example of the stereoscopic form layer.

In the present embodiment, the first printed layer 22 is an example of the color layer, and the second printed layer 23 is an example of the stereoscopic form layer, but the first printed layer 22 may be the stereoscopic form layer, and the second printed layer 23 may be the color layer. The thickness of the first printed layer 22 may be substantially the same as the thickness of the second printed layer 23. The thickness of the first printed layer 22 may be greater in comparison to the thickness of the second printed layer 23, and may be less.

### Third Embodiment

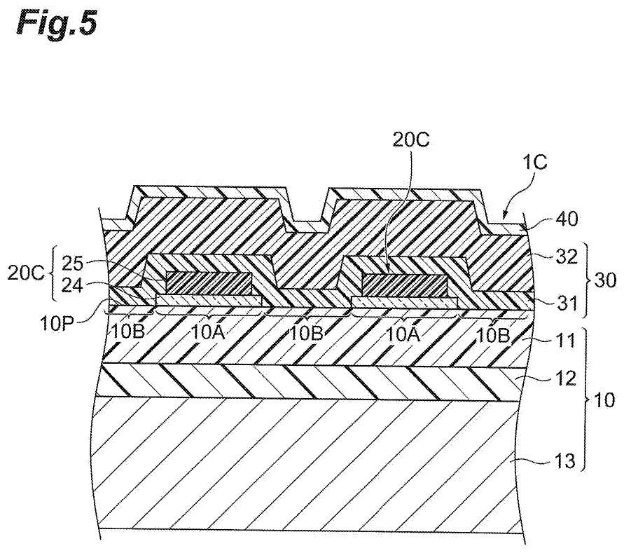

FIG. 5 is an example of a decorative sheet according to a third embodiment and is a schematic cross-sectional view along line II-II in FIG. 1. In FIG. 5, for ease of visibility, dimensions in the thickness direction with respect to dimensions in the width direction are indicated so as to be thicker than in the actual form. A decorative sheet 1C according to a third embodiment is provided with the same elements and structure as the decorative sheet 1A of the first embodiment or the decorative sheet 1B of the second embodiment. Accordingly, the following description is made focusing on different parts, common elements and structure are given the same reference numerals, and detailed description is omitted.

The decorative sheet 1C according to the third embodiment is provided with the base material 10, a printed portion 20C provided on the base material 10, the over-laminate film 30 provided on the base material 10 and the printed portion 20B, and as necessary, the surface-protecting layer 40. Differently from the printed portion 20A of the decorative sheet 1A, the printed portion 20C is provided with a plurality of printed layers.

For example, the plurality of printed layers include a first printed layer 24 and a second printed layer 25. The second printed layer 25 has a different planar pattern from the first printed layer 24 and is disposed on the first printed layer 24. In the plurality of printed layers 24 and 25 of the decorative sheet 1C, each printed layer 24 and 25 has planar patterns that are different from each other. In the present disclosure, “non-synchronous” has the meaning of each printed layer 24 and 25 having different planar patterns from each other. In a case where each printed layer 24 and 25 are non-synchronous, for example, it is possible to impart information of the shape that is not completely relevant to outer appearance information expressed by the first printed layer 24 in the second printed layer 25. For example, it is possible for a grain pattern to be expressed in the first printed layer 24 and a design, company logo, or the like with no relationship to the grain pattern to be expressed in the second printed layer 25.

In the present embodiment, the first printed layer 24 is a printed layer including a transparent ultraviolet light curing ink. With respect to the first printed layer 24, the second printed layer 25 includes colored ultraviolet light curing ink, and is the colored printed layer. The first printed layer 24 has a higher transparency than at least the transparency of the second printed layer 25. The first printed layer 24 is a layer in which the thickness of the printed portion 20C is thickened such that the three-dimensional shape is prominent, and is a layer prioritizing the three-dimensional shape function. The first printed layer 24 is an example of the stereoscopic form layer. The second printed layer 25 is a layer in which transparency is lower in comparison to at least the first printed layer 24 and prioritizes a color function independently imparting influence on color or pattern of the printed portion 20C. The second printed layer 25 is an example of the color layer.

In the present embodiment, the first printed layer 24 is an example of the stereoscopic form layer, and the second printed layer 25 is an example of the color layer, but the first printed layer 24 may be the color layer, and the second printed layer 25 may be the stereoscopic form layer. The thickness of the first printed layer 24 may be substantially the same as the thickness of the second printed layer 25. The thickness of the first printed layer 24 may be greater in comparison to the thickness of the second printed layer 25, and may be less.

### Fourth Embodiment

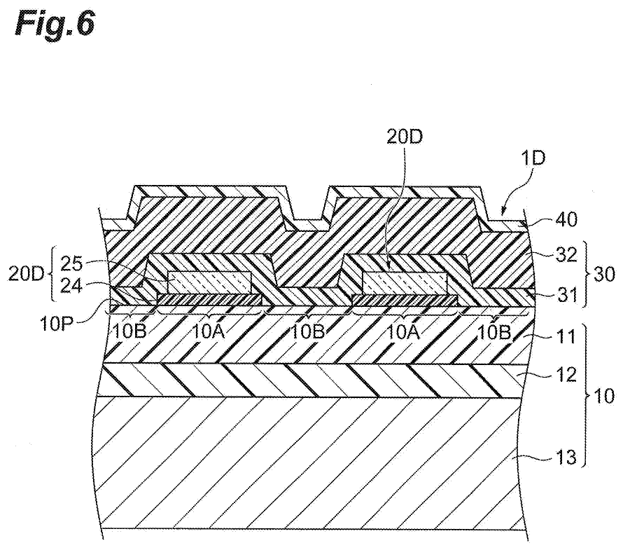

FIG. 6 is an example of a decorative sheet according to a fourth embodiment and is a schematic cross-sectional view along line II-II in FIG. 1. In FIG. 6, for ease of visibility, dimensions in the thickness direction with respect to dimensions in the width direction are indicated so as to be thicker than in the actual form. Except for the printed portion, a decorative sheet 1D according to a fourth embodiment is the same as the decorative sheet 1C of the third embodiment. Accordingly, the following description is made focusing on different parts, common elements and structure are given the same reference numerals, and detailed description is omitted.

The first printed layer 24 of the decorative sheet 1D according to the fourth embodiment includes colored ultraviolet light curing ink, and is the colored printed layer. With respect to the first printed layer 24, the second printed layer 25 is the printed layer including transparent ultraviolet light curing ink. The first printed layer 24 has a lower transparency than at least the second printed layer 25. The first printed layer 24 is a layer prioritizing the color function independently imparting influence on color or pattern of the printed portion 20D. The second printed layer 25 is an example of the color layer. The second printed layer 25 has a lower transparency than at least the first printed layer 24. The second printed layer 25 is a layer in which the thickness of the printed portion 20D is thickened such that the three-dimensional shape is prominent, and is a layer prioritizing a three-dimensional shape function. The second printed layer 25D is an example of the stereoscopic form layer. The thickness of the first printed layer 24 may be substantially the same as the thickness of the second printed layer 25. The thickness of the first printed layer 24 may be greater in comparison to the thickness of the second printed layer 25, and may be less.

### EXAMPLES

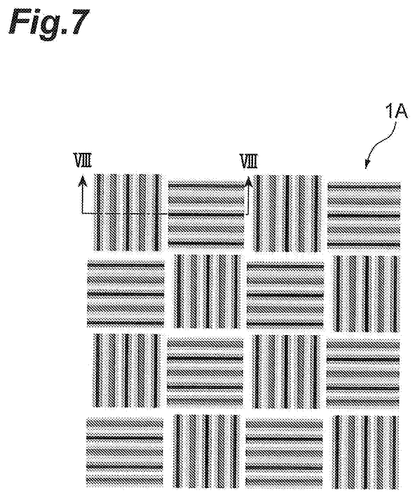

The decorative sheet will be further described using Examples of the present invention and comparative examples hereinafter, but the present invention is not limited to the examples described below. In the following description, for convenience of description, the elements or structure corresponding to the embodiments described above are given the same reference numerals as described above in FIGS. 7, 8, 9, and 10 and the sentences described below.

In the Examples, polymer compositions, crosslinking agents, pigments, and tackifiers used in the formation of the over-laminate film in the Examples are indicated in Table 1. In the following description “portion” and “percent” refer to mass unless otherwise stated.

TABLE 1

| | Composition |
|---|---|
| Tacky adhesive polymer 1 (ADH1) | BA - AA = 94:6 |
| Tacky adhesive polymer 2 (ADH2) | IOA - MA - AA = 70:22.5:7.5 |
| Tacky adhesive polymer 3 (ADH3) | BA - AN - AA = 93:3:4 |
| Tacky adhesive polymer 4 (ADH4) | 2EHA - BA - AN - AA = |
| | 58:36:1:5 |
| Tacky adhesive polymer 5 (ADH5) | 2MBA - AA = 90:10 |
| Tacky adhesive polymer 6 (ADH6) | BA - 2EHA - MA - AA = |
| | 54:30:10:6 |
| Amino group-containing | MMA - BMA - DMAEMA = |
| (meth)acrylic polymer 1 (HAP1) | 60:34:6 |
| Pigment 1 (white pigment) | Manufactured by DuPont (trademark) |
| | Titanium oxide Ti-Pure (trademark) |
| | R960 |
| Pigment 2 (silver pigment) | Aluminum paste 0215M, |
| | manufactured by Toyo Aluminum |
| Crosslinking agent 1 (CL1) | N,N,N′,N′-tetraglycidyl-1,3 |
| | benzenji (methanamine) (epoxy, |
| | manufactured by Mitsubishi Gas |
| | Chemical: TETRAD-X) |
| Crosslinking agent 2 (CL2) | 1,1′-isophthaloyl-bis |
| | (2-methyl aziridine) |
| | (Bisamide type, manufactured |
| | by 3M) |
| Crosslinking agent 3 (CL3) | Isocyanate, coronate L55E, |
| | manufactured by Tosoh Corporation |

Each abbreviation described in Table 1 indicate respective materials below.
MA: Methyl acrylate
MMA: Methyl methacrylate
BMA: Butyl methacrylate
DMAEMA: N,N-dimethyl aminoethyl methacrylate
BA: Butyl acrylate
AA: Acrylic acid
HEA: Hydroxyethyl acrylate
2EHA: 2-Ethylhexyl acrylate
Vac: Vinyl acetate
AN: Acrylonitrile
2MBA: 2 methyl butyl acrylate
IOA: Isooctyl acrylate
MIBK: Methyl isobutyl ketone

Measurement Conditions of Coefficient of Loss Tan δ of Adhesive Layer

The peak temperature of the coefficient of loss tan δ of the adhesive layer of the over-laminate film used in the Examples was measured using an ARES dynamic viscoelasticity measuring device (manufactured by T.A. Instruments Japan, Shinagawa-ku, Tokyo, Japan). The adhesive was formed into a film having a dry thickness of approximately 3 mm, and test samples having a diameter of approximately 7.9 mm were produced by punching out the film. The peak temperature of the coefficient of loss tan δ (=shear loss elastic modulus G″/shear storage elastic modulus G′) was obtained resulting from measuring the shear storage elastic modulus G′ and the shear loss elastic modulus G″ in a shear mode at a frequency of 1.0 Hz, while the temperature was raised at a rate of temperature increase of 5.0° C./sec from −20° C. to 150° C.

Measurement Conditions of Printed Portion, Thickness of Adhesive Layer, and Surface Roughness (Ra, Rz)

The thickness of each of the printed portion, the over-laminate film, and the adhesive layer were measured using a thickness measurement device ABS digimatic indicator ID-CX upright gage (manufactured by Mitutoyo Corporation). The test sample was measured interposed between a measurement instrument and a probe, and each thickness was obtained. The surface roughness was measured using surface roughness measurement device HANDYSURF E-35A (manufactured by Tokyo Seimitsu Co., Ltd.). Surface roughness (Ra, Rz) of a pickup portion placed on the test sample was obtained.

### Example 1

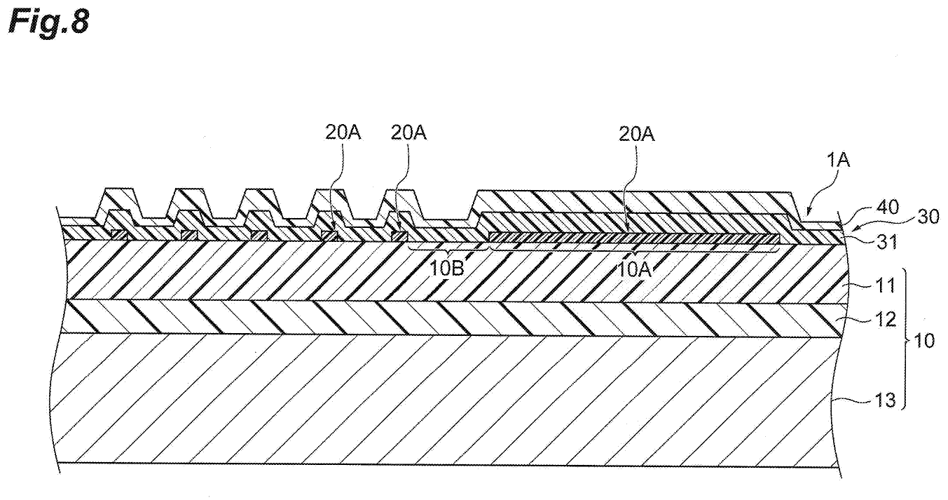

The base material 10 of the decorative sheet 1A (refer to FIGS. 7 and 8) is provided with the graphic film 11, the adhesive layer 12, and the release liner 13. Control Tuck™ graphic film IJ180-10 (manufactured by 3M) was used as the graphic film 11. Graphic film IJ180-10 is a white decorative adhesive sheet.

The printed portion 20A was formed in a region of A4 size (vertically 297 mm, horizontally 210 mm) on the graphic film 11 using inkjet printer UJF-3042FX (manufactured by Mimaki Engineering Co., Ltd.). Ultraviolet light curing ink LUS-200 (manufactured by 3M) for inkjet printers was used as the ink. A carbon fiber weave pattern such as indicated in FIGS. 7 and 8 was printed on the graphic film 11. The carbon fiber weave pattern was a lattice shape with a gap of 1.5 mm in a vertical direction and a gap of 1.5 mm in a lateral direction. Gradation having ink concentration of 0% to 100% to 0% was provided on a lattice line in the width direction of the line. The drawing resolution was 720×600 dpi. In the printing method, single direction printing was performed by 16 passes in the sub-scanning direction. An ultraviolet light irradiation level was high level. Overlapping printing was performed and the printed portion 20A with thickness 21 μm was formed by printing a total of three times.

After the film layer and the adhesive layer were each produced under the following conditions, the over-laminate film 30 was obtained by bonding. The film layer of the over-laminate film with a thickness of 50 μm was obtained by coating blue soft polyvinyl chloride (PVC) resin solution JS16104ORG manufactured by 3M on a surface subjected to peeling treatment of a PET film (Teijin DuPont Films Ltd., Teijin Tetron Film G2 (trade name)) using the knife coater, then drying.

Next, the adhesive layer was produced under the following conditions. White pigment dispersion solution was prepared by mixing pigment 1, amino group-containing (meth)acrylic polymer 1 (HAP1), and MIBK. The mass ratio of pigment 1 and HAP1 was 5:1 in terms of solid content. Solid content of the white pigment dispersion solution was approximately 66%. White adhesive solution was prepared by mixing white pigment dispersion solution, tacky adhesive polymer 1 (ADH1), and crosslinking agent 1 (CL1). The amount used of each component was 100 parts by mass of ADH1, 8 parts by mass of HAP1, and 40 parts by mass of pigment 1. CL1 was added to the white adhesive solution. The CL1 was 0.1 parts by mass with respect to 100 parts by mass of ADH1. The white adhesive solution was coated on a single-sided silicone treated double-sided polyethylene laminated release sheet using the knife coater. An application layer was dried for 5 minutes at 95° C. and the white tacky adhesive layer 31 was obtained with thickness of 30 μm. The peak temperature of the tan δ of the adhesive layer was −5° C.

Laminator AE-1600 (manufactured by ACCO brands Japan) was used as the roll to roll application device and the over-laminate film 30 was bonded (laminated) to the base material 10. The first nip roller 75A contacting the over-laminate film 30 was heated to 65° C., and the laminating speed was approximately 35 cm per second. The height of the over-laminate film 30 on the printed region 10A with reference to the surface of the base material 10 was high in comparison to the height of the over-laminate film 30 on the peripheral region 10B, and the difference of height was a maximum of 21 μm.

The surface roughness Ra of the over-laminate film 30 laminated on the base material 10 and the printed portion 20A was 4.6 μm, and the surface roughness Rz was 20.9 μm. The surface roughness change ratio Ra (ratio) of the over-laminate film 30 was 557%.

### Example 2

Other than the number of times of printing on the printed portion being from three to four and the thickness of the printed portion being 28 μm, the decorative sheet was produced in the same manner as in Example 1.

### Example 3

Other than the over-laminate film being a black low gloss vinyl chloride resin (PVC) and the adhesive layer of the over-laminate film being transparent, the decorative sheet was produced in the same manner as in Example 1. Specifically, other than using black soft polyvinyl chloride (PVC) resin solution JS15000RG manufactured by 3M, the film layer of the over-laminate film was produced with the same method as in Example 1. Adhesive solution was used as the adhesive layer mixing 100 parts by mass ADH1 and only 0.1 parts by mass CL1 without using the white pigment dispersion solution.

### Example 4

Other than the number of times of printing on the printed portion being from three to four, the thickness of the printed portion being 28 μm, and the over-laminate film of Example 3 being used, the decorative sheet was produced in the same manner as in Example 1.

### Example 5

Other than the over-laminate film of Example 3 being used, the decorative sheet was produced in the same manner as in Example 1.

### Example 6

Other than the number of times of printing on the printed portion being from three to four, the thickness of the printed portion being 28 μm, and the over-laminate film of Example 5 being used, the decorative sheet was produced in much the same manner as in Example 1.

### Example 7

Other than being a black high gloss vinyl chloride resin (PVC) in the same manner as the over-laminate film of Example 3, being provided with the surface-protecting layer, the peak temperature of the tan δ of the adhesive layer being −7° C., and the adhesive layer of the over-laminate film being transparent, the decorative sheet was produced in the same manner as in Example 1. Specifically, adhesive solution was used in the adhesive layer of the over-laminate film by mixing 100 parts by mass ADH2 and 0.2 parts by mass of CL2 without using the white pigment dispersion solution. The surface-protecting layer was formed by drying after surface-protecting material CC-2SOL (manufactured by 3M) including fluororesin was coated. The thickness of the surface-protecting layer wsyuuseas approximately 2 μm.

### Example 8

Other than the number of times of printing on the printed portion being from three to four, the thickness of the printed portion being 28 μm, and the same over-laminate film and surface-protecting layer as in Example 7 being used, the decorative sheet was produced in the same manner as in Example 1.

Table 2 and Table 3 are tables indicating production conditions of the decorative sheet, the configuration of the decorative sheet, a measurement result of the over-laminate film, and an evaluation result of sharpness in Example 1 to Example 8. Sharpness evaluation has the meaning of evaluating whether or not the over-laminate film has the three-dimensional shape following the three-dimensional shape of the printed portion. Table 2 indicates Example 1 to Example 4, and Table 3 indicates Example 5 to Example 8. In the sharpness evaluation, concerning the number of stripes formed by the printed portion of the decorative sheet, whether the produced number and the number able to be visually recognized match was investigated, and “A” is evaluated when the numbers match. That is, sharpness evaluation has the meaning of evaluating whether or not the over-laminate film has the three-dimensional shape following the three-dimensional shape of the printed portion. In Example 1 to Example 8, sharpness evaluations are all “A”, and it was indicated that the over-laminate film has the three-dimensional shape following the three-dimensional shape of the printed portion. The height of the over-laminate film from the surface of the base material on the printed region is higher in comparison to the height of the over-laminate film from the surface of the base material in the peripheral region, and in Table 1 and Table 2, difference of the heights are represented as “film height difference ΔH (μm)” (same hereinafter in the present specification).

TABLE 2

| | | Example 1 | Example 2 | Example 3 | Example 4 |
|---|---|---|---|---|---|
| Substrate | Material | IJ180-10 | IJ180-10 | IJ180-10 | IJ180-10 |
| Printed portion | Thickness (μm) | 21 | 28 | 21 | 28 |
| Surface- | Material | None | None | None | None |
| protecting | Thickness (μm) | 0 | 0 | 0 | 0 |
| layer | | | | | |
| Over-laminate | Material | PVC | PVC | PVC | PVC |
| film layer | | (Blue high | (Blue high | (Black low | (Black low |
| | | gloss) | gloss) | gloss) | gloss) |
| | Thickness (μm) | 50 | 50 | 50 | 50 |
| Adhesive | Color | White | White | Transparent | Transparent |
| layer | Thickness (μm) | 30 | 30 | 30 | 30 |
| | tanδ peak | −5 | −5 | −5 | −5 |
| | temperature (° C.) | | | | |

| | | | | |
|---|---|---|---|---|
| Film height difference ΔH (μm) | 21 | 28 | 20 | 25 |
| Ra (μm) | 4.6 | 4.5 | 3.3 | 4.1 |
| Rz (μm) | 20.9 | 32.3 | 20.5 | 19.0 |
| Ra (ratio) (%) | 557 | 543 | 371 | 486 |
| Sharpness evaluation | A | A | A | A |

TABLE 3

| | | Example 5 | Example 6 | Example 7 | Example 8 |
|---|---|---|---|---|---|
| Substrate | Material | IJ180-10 | IJ180-10 | IJ180-10 | IJ180-10 |
| Printed portion | Thickness (μm) | 21 | 28 | 21 | 28 |
| Surface- | Material | None | None | Fluororesin | Fluororesin |
| protecting | Thickness (μm) | 0 | 0 | 2 | 2 |
| layer | | | | | |
| Over-laminate | Material | PVC | PVC | PVC | PVC |
| film layer | | (Black | (Black | (Black high | (Black high |
| | | high gloss) | high gloss) | gloss) | gloss) |
| | Thickness (μm) | 50 | 50 | 50 | 50 |
| Adhesive | Color | Transparent | Transparent | Transparent | Transparent |
| layer | Thickness (μm) | 30 | 30 | 30 | 30 |
| | tanδ peak | −5 | −5 | −7 | −7 |
| | temperature (° C.) | | | | |

| | | | | |
|---|---|---|---|---|
| Film height difference ΔH (μm) | 22 | 30 | 15 | 19 |
| Ra (μm) | 2.7 | 4.2 | 1.9 | 3.4 |
| Rz (μm) | 16.8 | 25.6 | 10.6 | 17.1 |
| Ra (ratio) (%) | 286 | 500 | 111 | 278 |
| Sharpness evaluation | A | A | A | A |

### Example 9

Scotchcal™ clear graphic film IJ8150 (manufactured by 3M) was used as the base material of the decorative sheet. Clear graphic film IJ8150 is a transparent decorative adhesive sheet. In Example 9, the printed portion was formed in a region of A4 size (vertically 297 mm, horizontally 210 mm) on the graphic film using inkjet printer UJF-3042FX (manufactured by Mimaki Engineering Co., Ltd.). The printed portion is formed to represent a logo design of 3M. The logo size was vertical 7 mm and horizontal 15 mm. Ultraviolet light curing ink LUS-200 (manufactured by 3M) for inkjet printers was used as the ink. Ink concentration was magenta 100% and yellow 100%. The drawing resolution was 720×600 dpi. In the printing method, single direction printing was performed by 16 passes in the sub-scanning direction. An ultraviolet light irradiation level was high level. The printed portion with thickness 28 μm was formed by printing two times.

The over-laminate film is the same as in Example 1 and is a film including a blue high gloss vinyl chloride resin (PVC) with thickness of 50 μm and a white tacky adhesive layer with thickness of 30 μm. In Example 9, laminator AE-1600 (manufactured by ACCO brands Japan) was used as the roll to roll application device and the over-laminate film was bonded (laminated) to the base material. The first nip roller contacting the over-laminate film was heated to 65° C., and the laminating speed was approximately 35 cm per second. The surface roughness Ra of the over-laminate film laminated on the base material and the printed portion was 4.2 μm, and the surface roughness Rz was 23.4 μm. The surface roughness change ratio Ra (ratio) of the over-laminate film was 740%.

In Example 9, when viewing the decorative sheet from the upper side (front side), and when viewing from the lower side (rear side). It is possible to visually recognize characters and diagrams configured by the printed portion. In comparison to the characters and diagrams when viewing from the lower side (rear side), in the characters and diagrams when viewing the decorative sheet from the upper side (front side), an image effect is confirmed of a mirror image outer appearance in which left and right of the characters and diagrams appear to be reversed.

### Example 10

Other than the over-laminate film being a white high gloss vinyl chloride resin (PVC), the thickness of film layer of the over-laminate film being 47 μm, the thickness of the adhesive layer being 40 μm, and solvent inkjet printing being carried out on the over-laminate film using JV5 pure ink for solvent ink (manufactured by Mimaki Engineering Co., Ltd.), the decorative sheet was produced in the same manner as in Example 9. Specifically, other than using white soft polyvinyl chloride (PVC) resin solution 0025-10ORG manufactured by 3M, the film layer of the over-laminate film was produced with the same method as in Example 1.

In Example 10, when viewing the decorative sheet from the upper side (front side), and when viewing from the lower side (rear side). It is possible to visually recognize characters and diagrams configured by the printed portion. In comparison to the characters and diagrams when viewing from the lower side (rear side), in the characters and diagrams when viewing the decorative sheet from the upper side (front side), an image effect is confirmed of a mirror image outer appearance in which left and right of the characters and diagrams appear to be reversed. Since the height of the over-laminate film from the surface of the base material on the printed region is higher in comparison to the height of the over-laminate film from the surface of the base material on the peripheral region, it was possible for the over-laminate film positioned on the printed region to form a security mark for counterfeiting prevention by solvent inkjet printing.

Table 4 is a table indicating production conditions of the decorative sheet, the configuration of the decorative sheet, a measurement result of the over-laminate film, and an evaluation result of sharpness in Example 9 and Example 10. Sharpness of the over-laminate film according to Example 9 and Example 10 was favorable, and it was possible to evaluate that the over-laminate film had the three-dimensional shape following the three-dimensional shape of the printed portion.

TABLE 4
Table 4

| | | Example 9 | Example 10 |
|---|---|---|---|
| Substrate | Material | IJ8150 | IJ8150 |
| Printed | Thickness | 60 | 60 |
| portion | (μm) | | |
| Surface- | Material | None | None |
| protecting | Thickness | 0 | 0 |
| layer | (μm) | | |
| Over-laminate | Material | PVC | PVC |
| film layer | | (Blue high | (White high |
| | | gloss) | gloss) |
| | Thickness | 50 | 47 |
| | (μm) | | |
| Adhesive | Color | White | White |
| layer | Thickness | 30 | 40 |
| | (μm) | | |
| | tanδ | −5 | −5 |
| | peak | | |
| | temperature | | |
| | (° C.) | | |

| | | |
|---|---|---|
| Ra (μm) | 4.2 | 4.2 |
| Rz (μm) | 23.4 | 24.3 |
| Ra (ratio) (%) | 740 | 367 |

### Example 11

Scotchcal™ clear graphic film IJ8150 (manufactured by 3M) was used as the base material. Graphic film IJ8150 is a transparent decorative adhesive sheet. In Example 11, the printed portion was formed in a region of A4 size (vertically 297 mm, horizontally 210 mm) on the graphic film using inkjet printer UJF-3042FX (manufactured by Mimaki Engineering Co., Ltd.). The color layer having a radial gradient design was formed on the printed portion. Ink concentration of the color layer was provided at gradation of cyan 0% to 100%, magenta of 0% to 100%, and yellow 0% to 100%, and the number of times of printing was one time. Ultraviolet light curing ink LUS-200 (manufactured by 3M) for inkjet printers was used as the ink. The drawing resolution was 720×600 dpi. In the printing method, single direction printing was performed by 16 passes in the sub-scanning direction. An ultraviolet light irradiation level was high level.

In Example 11, the stereoscopic form layer was laminated on the color layer. The stereoscopic form layer has a carbon fiber weave pattern such as indicated in FIGS. 7 and 8. Stripe shape lines were provided in square shapes (vertical 1.5 mm, horizontal 1.5 mm) respectively configuring the lattice of the carbon fiber weave pattern, and ink concentration in the width direction of the line was provided at a gradation of 0% to 100% to 0%. The lattice of the carbon fiber weave pattern was printed using a single clear ink, and the number of times of printing was three times. The thickness of the printed portion combining the color layer and the stereoscopic form layer was 30 μm.

Table 5 is a table indicating names of materials contained in the clear ink used in Example 11 and mass % occupied by each material in the clear ink.

TABLE 5

| Material name | Mass % |
|---|---|
| 9740i | 25.50 |
| 9801 | 67.05 |
| TPO | 7.45 |

In Table 5, 9740i and 9801 are ultraviolet light curing inks (manufactured by 3M). TPO is 2,4,6-trimethylbenzoyl-diphenyl phosphine oxide (manufactured by BASF Corp.) of the photopolymerization initiator.

The over-laminate film 30 was a film including the same white high gloss vinyl chloride resin (PVC) as in Example 10. However, the thickness of the over-laminate film 30 was adjusted to 47 μm. The white tacky adhesive layer with the same thickness of 30 μm as in Example 1 was used as the adhesive layer 31 of the over-laminate film 30. In Example 11, solvent inkjet printing was carried out on the over-laminate film 30 using JV5 pure ink for solvent inkjet printers (manufactured by Mimaki Engineering Co., Ltd.).

The roll to roll application device and laminator AE-1600 (manufactured by ACCO brands Japan) were used to bond (laminate) the over-laminate film on the base material. The first nip roller contacting the over-laminate film was heated to 65° C., and the laminating speed was approximately 35 cm per second. The surface roughness Ra of the over-laminate film laminated on the base material and the printed portion was 2.6 μm, and the surface roughness Rz was 15.3 μm. The surface roughness change ratio Ra (ratio) of the over-laminate film was 767%.

In Example 11, the outer appearance was confirmed based on a difference of height of the over-laminate film. That is, the outer appearance was confirmed such that the height of the over-laminate film on the printed region with reference to the surface of the base material was high in comparison to the height of the over-laminate film on the peripheral region.

When viewing the decorative sheet from the upper side (front side), and when viewing from the lower side (rear side), it is possible to visually recognize characters and diagrams configured by the printed portion with the same shape and the same color. In comparison to the characters and diagrams when viewing from the lower side (rear side), in the characters and diagrams when viewing the decorative sheet from the upper side (front side), an image effect is also confirmed of a mirror image outer appearance in which left and right of the characters and diagrams appear to be reversed. Since the printed layers are non-synchronous where each printed layer has a different planar pattern from each other, an impression was made of a new decoration or appearance on the stereoscopic form layer by imparting information of a shape that is totally unrelated to the outer appearance information expressed by the color layer.

### Example 12

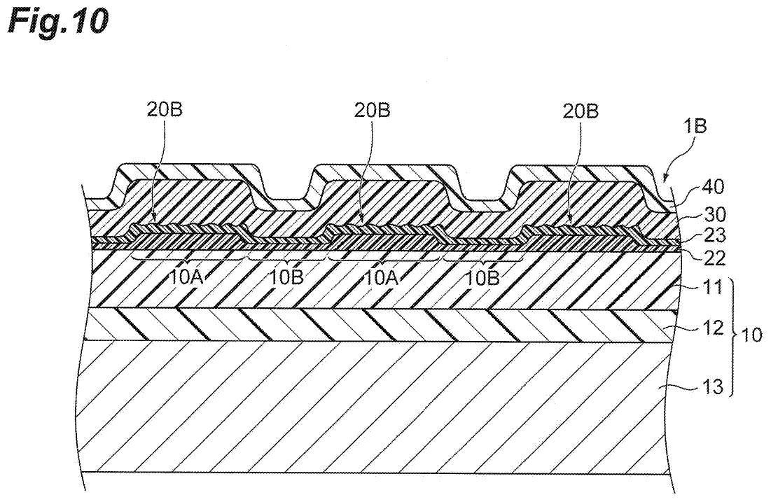

The base material 10 of the decorative sheet 1B according to Example 12 (refer to FIG. 10) was provided with the graphic film 11, the adhesive layer 12, and the release liner 13. Scotchcal™ graphic film IJ5331 (manufactured by 3M) was used as the graphic film 11. The graphic film IJ180-10 was a white decorative adhesive sheet.

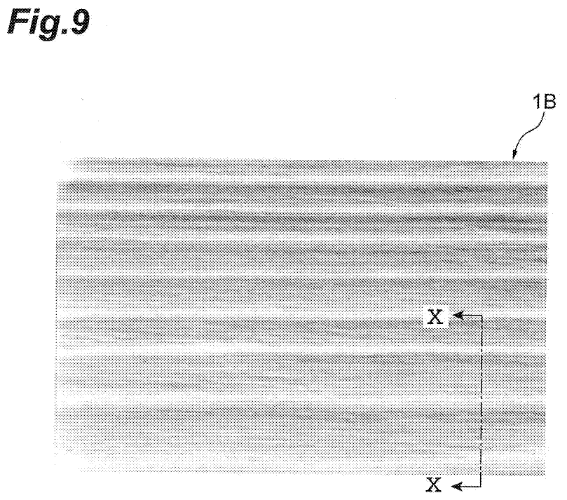

In Example 12, the printed portion 20B was formed in a region of A4 size (vertically 297 mm, horizontally 210 mm) on the graphic film 11 using inkjet printer UJF-3042FX (manufactured by Mimaki Engineering Co., Ltd.). The color layer 22 having the grain pattern as indicated in FIGS. 9 and 10 was formed on the printed portion 20B. Ink concentration of the color layer 22 was provided at gradation of cyan 0% to 100%, magenta of 0% to 100%, and yellow 0% to 100%, and the number of times of printing was one time. Ultraviolet light curing ink LUS-200 (manufactured by 3M) for inkjet printers was used as the ink. The drawing resolution was 720×600 dpi. In the printing method, single direction printing was performed by 16 passes in the sub-scanning direction. An ultraviolet light irradiation level was high level.

As indicated in FIG. 10, the stereoscopic form layer 23 with higher transparency than the color layer 22 was laminated on the color layer 22. The stereoscopic form layer 23 has a woodgrain pattern. The dimensions of the woodgrain in the stereoscopic form layer 23 were formed to be the same as the dimensions of the woodgrain in the color layer 22, and a plurality of synchronous layers were formed in which two color layers have substantially the same planar pattern as each other. The woodgrain pattern forming the stereoscopic form layer 23 is converted to monotone and a woodgrain conduit part is extracted. The woodgrain pattern in the color layer 22 was printed using the same single clear ink as in Example 11, and the number of times of printing was six times. The thickness of the printed portion combining the color layer and the stereoscopic form layer was 45 μm.

The over-laminate film 30 was a film including a transparent low gloss acrylic resin. The thickness of the over-laminate film 30 was 13 μm. The transparent adhesive layer with the same thickness of 30 μm as in Example 3 was used as the adhesive layer 31. Other than transparent soft acrylic resin solution C110-SOL manufactured by 3M being used, the film layer including acrylic resin was produced using a similar method to Example 1. The surface-protecting layer was formed by drying after surface-protecting material CC-2SOL (manufactured by 3M) including fluororesin was coated. The thickness of the surface-protecting layer was approximately 4 μm.

In Example 12, solvent inkjet printing was carried out on the over-laminate film 30 using JV5 pure ink for solvent inkjet printers (manufactured by Mimaki Engineering Co., Ltd.). The surface-protecting layer 40 was provided on the over-laminate film layer 30. After surface-protecting material CC-2SOL (manufactured by 3M) including fluororesin is coated, the surface-protecting layer 40 was formed by drying. The thickness of the surface-protecting layer was approximately 2 μm.

Roll to roll application device and laminator AE-1600 (manufactured by ACCO brands Japan) were used to bond (laminate) the over-laminate film 30 on the base material 10. The first nip roller 75A contacting the over-laminate film 30 was heated to 65° C., and the laminating speed was approximately 35 cm per second. The surface roughness Ra of the over-laminate film 30 laminated on the base material 10 and the printed portion 20B was 7.3 μm, and the surface roughness Rz was 35.7 μm. The surface roughness change ratio Ra (ratio) of the over-laminate film 30 was 356%.

In Example 12, the outer appearance was confirmed based on the difference of height of the over-laminate film 30, that is, an outer appearance is confirmed in which height of the over-laminate film 30 from a surface of the base material 10 on the printed region 10A is higher in comparison to a height of the over-laminate film 30 from the surface of the base material 10 in the peripheral region 10B. Since solvent inkjet printing was carried out on the over-laminate film 30, it was possible to visually recognize the characters or diagrams printed on the over-laminate film 30. Since the printed layers are synchronous where each printed layer 22 and 23 has substantially the same planar pattern as each other, the three-dimensional shape of the printed portion 20B, and in particular, the shape in the height direction from the base material 10 are further emphasized. It was possible for the over-laminate film 30 positioned on the printed region 10A to form a security mark for counterfeiting prevention by solvent inkjet printing.

### Example 13

Other than the color layer being laminated on the stereoscopic form layer, the decorative sheet was produced under the same conditions as in Example 12. In Example 13, differently from Example 12, the stereoscopic form layer was laminated on the color layer. The stereoscopic form layer has a woodgrain pattern. The dimensions of the woodgrain forming the stereoscopic form layer were formed to be the same as the dimensions of the woodgrain in the color layer, and a plurality of synchronous layers were formed in which the color layer and the stereoscopic form layer have substantially the same planar pattern as each other. The woodgrain pattern forming the stereoscopic form layer is converted to monotone and the woodgrain conduit part is extracted. The woodgrain pattern forming the stereoscopic form layer was printed using the same single clear ink as in Example 11, and the number of times of printing was three times. The color layer having a woodgrain design was formed on the printed portion. The number of times of printing for the color layer was two times. The thickness of the printed portion combining the color layer and the stereoscopic form layer was 25 μm.

In Example 13, although the stereoscopic form layer was laminated on the color layer, the printed layers are synchronous where each printed layer has substantially the same planar pattern as each other, and the three-dimensional shape of the printed portion, in particular, the shape in the height direction from the base material were further emphasized. The outer appearance was confirmed based on the difference of height of the over-laminate film, that is, an outer appearance in which height of the over-laminate film from a surface of the base material on the printed region is higher in comparison to a height of the over-laminate film from the surface of the base material in the peripheral region.

Table 6 is a table indicating production conditions of the decorative sheet, the configuration of the decorative sheet, and a measurement result of the overlay film in Example 11 to Example 13. Sharpness of the overlay film according to Example 11 to Example 13 was favorable, and it was possible to evaluate that the overlay film was the three-dimensional shape following the three-dimensional shape of the printed portion.

TABLE 6

| | | Example 11 | Example 12 | Example 13 |
|---|---|---|---|---|
| Substrate | Material | IJ8150 | IJ5331 | IJ5331 |
| Color layer (I) | Printing number | 1 | 1 | 3 |
| | of times | | | |
| Stereoscopic form | Printing number | 3 | 6 | 2 |
| layer (II) | of times | | | |
| | Combined | 30 | 45 | 25 |
| | thickness (μm) | | | |
| | of (I) and (II) | | | |
| Printed portion | Width of | Non- | Synchronous | Synchronous |
| | plurality of | synchronous | | |
| | layers | | | |
| Surface- | Material | None | Fluororesin | Fluororesin |
| protecting | Thickness (μm) | 0 | 4 | 4 |
| layer | | | | |
| Over-laminate | Material | PVC | Acrylic | Acrylic |
| film layer | | (White high | (Transparent | (Transparent |
| | | gloss) | low gloss) | low gloss) |
| | Thickness (μm) | 47 | 13 | 13 |
| Adhesive | Color | White | Transparent | Transparent |
| layer | Thickness (μm) | 30 | 8 | 8 |
| | tanδ peak | −5 | −5 | −5 |
| | temperature (° C.) | | | |

| | | | |
|---|---|---|---|
| Ra (μm) | 2.6 | 7.3 | 3.4 |
| Rz (μm) | 15.3 | 35.7 | 19.8 |
| Ra (ratio) (%) | 767 | 356 | 113 |

### Example 14

ControlTac™ graphic film IJ180-10 (manufactured by 3M) was used as the base material of the decorative sheet according to Example 14. The graphic film IJ180-10 was a white decorative adhesive sheet. In Example 14, the printed portion was formed in a region of A4 size (vertically 297 mm, horizontally 210 mm) on the graphic film using inkjet printer UJF-3042FX (manufactured by Mimaki Engineering Co., Ltd.). Ultraviolet light curing ink LUS-200 (manufactured by 3M) for inkjet printers was used as the ink. The carbon fiber weave pattern was printed on the graphic film, the carbon fiber weave pattern was a lattice shape with a gap of 1.5 mm in a vertical direction and a gap of 1.5 mm in a lateral direction. Gradation having ink concentration of 0% to 100% to 0% was provided on a lattice line in the width direction of the line. The drawing resolution was 720×600 dpi. In the printing method, single direction printing was performed by 16 passes in the sub-scanning direction. An ultraviolet light irradiation level was high level. The printed portion with thickness 21 μm was formed by overlapping printing three times.

The film including the transparent high gloss acrylic resin was used as the over-laminate film. The thickness of the film layer of the over-laminate film was 50 μm. The transparent adhesive layer with the same thickness of 30 μm as in Example 3 was used as the adhesive layer 31. Other than the transparent soft acrylic resin solution B75-SOL manufactured by 3M being used, the film layer including acrylic resin was produced using a similar method to Example 1. After surface-protecting material SCLSOL (manufactured by 3M) formed of polyurethane resin is coated, the surface-protecting layer was formed by drying. The thickness of the surface-protecting layer was approximately 2 μm.

In Example 14, laminator AE-1600 (manufactured by ACCO brands Japan) was used as the roll to roll application device and the over-laminate film was bonded to the base material. The first nip roller contacting the over-laminate film was heated to 65° C., and the laminating speed was approximately 35 cm per second. The surface roughness Ra of the over-laminate film laminated on the base material and the printed portion was 2.8 μm, and the surface roughness Rz was 12.3 μm. The surface roughness change ratio Ra (ratio) of the over-laminate film was 180%.

### Example 15

Other than the surface-protecting layer not being provided, the over-laminate film being a transparent high gloss vinyl chloride resin (PVC), and the peak temperature of the tan δ of the adhesive layer being −17° C., the decorative sheet was produced in the same manner as in Example 14. Specifically, other than the transparent soft polyvinyl chloride resin solution JS1900ORG manufactured by 3M being used, the film layer including transparent high gloss vinyl chloride resin (PVC) was produced using a similar method to Example 1. Other than the adhesive solution being prepared by mixing 100 parts by mass ADH3 and only 2.8 parts by mass CL3 without using the white pigment dispersion solution, the adhesive layer was produced using a similar method to Example 1.

### Example 16

Other than the surface-protecting layer not being provided, the over-laminate film being a white high gloss vinyl chloride resin (PVC), the thickness of the film layer of the over-laminate film being 70 μm, the color of the adhesive layer being silver, and the peak temperature of the tan δ of the adhesive layer being −17° C., the decorative sheet was produced in the same manner as in Example 14. Specifically, other than the white soft polyvinyl chloride resin solution 0025-10ORG manufactured by 3M being used, the film layer including white high gloss vinyl chloride resin (PVC) was produced using a similar method to Example 1. Other than the adhesive solution being prepared by mixing 100 parts by mass ADH3, 5.7 parts by mass pigment 2, and 2.8 parts by mass CL3 without using the white pigment dispersion solution, as the adhesive layer, the adhesive layer was produced using a similar method to Example 1.

### Example 17

Other than the surface-protecting layer not being provided, the over-laminate film being a transparent high gloss vinyl chloride resin (PVC), and the peak temperature of the tan δ of the adhesive layer being −7° C., the decorative sheet was produced in the same manner as in Example 14. Specifically, other than the transparent soft polyvinyl chloride resin solution JS1900ORG manufactured by 3M being used, the film layer including transparent high gloss vinyl chloride resin (PVC) was produced using a similar method to Example 1. The adhesive layer was produced using a similar method to Example 7.

### Example 18

Other than the surface-protecting layer not being provided, the over-laminate film being a white high gloss vinyl chloride resin (PVC), the color of the adhesive layer being gray, and the peak temperature of the tan δ of the adhesive layer being −7° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 17.

### Example 19

Other than the over-laminate film being a white high gloss vinyl chloride resin (PVC), the color of the adhesive layer being gray, and the peak temperature of the tan δ of the adhesive layer being −7° C., the decorative sheet was produced in the same manner as in Example 1. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 17. After surface-protecting material SCLSOL (manufactured by 3M) formed of polyurethane resin is coated, the surface-protecting layer was formed by drying. The thickness of the surface-protecting layer was approximately 2 μm.

### Example 20

Other than the surface-protecting layer not being provided, the over-laminate film being a black high gloss vinyl chloride resin (PVC), the color of the adhesive layer being gray, and the peak temperature of the tan δ of the adhesive layer being −7° C., the decorative sheet was produced in the same manner as in Example 14. Specifically, other than the black soft polyvinyl chloride resin solution JS1500ORG manufactured by 3M being used, the film layer including black high gloss vinyl chloride resin (PVC) was produced using a similar method to Example 1. The same adhesive layer was used as in Example 17.

### Example 21

Other than the surface-protecting layer not being provided, the over-laminate film being a black high gloss vinyl chloride resin (PVC), the thickness of the film layer of the over-laminate film being 86 μm, the color of the adhesive layer being gray, and the peak temperature of the tan δ of the adhesive layer being −7° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Example 17.

### Example 22

Other than the over-laminate film being a white high gloss vinyl chloride resin (PVC), and the peak temperature of the tan δ of the adhesive layer being −14° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. Other than the adhesive solution being prepared by mixing 100 parts by mass ADH4 and 0.2 parts by mass of CL2 without using the white pigment dispersion solution, the adhesive layer was produced using a similar method to Example 1. After surface-protecting material SCLSOL (manufactured by 3M) formed of polyurethane resin is coated, the surface-protecting layer was formed by drying. The thickness of the surface-protecting layer was approximately 2 μm.

### Example 23

Other than the surface-protecting layer not being provided, the over-laminate film being a white high gloss vinyl chloride resin (PVC), and the peak temperature of the tan δ of the adhesive layer being −14° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 22.

### Example 24

Other than the surface-protecting layer not being provided, the over-laminate film being a black high gloss vinyl chloride resin (PVC), and the peak temperature of the tan δ of the adhesive layer being −14° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Example 22.

### Example 25

Other than the surface-protecting layer not being provided, the over-laminate film being a black high gloss vinyl chloride resin (PVC), the thickness of the film layer of the over-laminate film being 86 μm, and the peak temperature of the tan δ of the adhesive layer being −14° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Example 22.

### Example 26

Other than the surface-protecting layer not being provided, the over-laminate film being a white high gloss vinyl chloride resin (PVC), and the peak temperature of the tan δ of the adhesive layer being −6° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. Other than the 100 parts by mass ADH5 and 0.15 parts by mass of CL2 being used, the adhesive layer was produced using a similar method to Example 22.

### Example 27

Other than the over-laminate film being a white high gloss vinyl chloride resin (PVC), and the peak temperature of the tan δ of the adhesive layer being −6° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 26. After surface-protecting material SCLSOL (manufactured by 3M) formed of polyurethane resin is coated, the surface-protecting layer was formed by drying. The thickness of the surface-protecting layer was approximately 2 μm.

### Example 28

Other than the surface-protecting layer not being provided, the over-laminate film being a black high gloss vinyl chloride resin (PVC), and the peak temperature of the tan δ of the adhesive layer being −6° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Example 26.

### Example 29

Other than the surface-protecting layer not being provided, the over-laminate film being a black high gloss vinyl chloride resin (PVC), the thickness of the film layer of the over-laminate film being 86 μm, and the peak temperature of the tan δ of the adhesive layer being −6° C., the decorative sheet was produced in the same manner as in Example 14. Specifically, other than the black soft polyvinyl chloride solution JS15000RG manufactured by 3M being used, the film layer including black high gloss vinyl chloride resin (PVC) was produced using a similar method to Example 1. The same adhesive layer was used as in Example 26.

### Example 30

Other than the surface-protecting layer not being provided, the over-laminate film being a white high gloss vinyl chloride resin (PVC), and the color of the adhesive layer being white, the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 1.

### Example 31

Other than the over-laminate film being a white high gloss vinyl chloride resin (PVC), and the color of the adhesive layer being white, the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Example 1. After surface-protecting material SCLSOL (manufactured by 3M) formed of polyurethane resin is coated, the surface-protecting layer was formed by drying. The thickness of the surface-protecting layer was approximately 2 μm.

### Example 32

Other than the surface-protecting layer not being provided, the over-laminate film being a black high gloss vinyl chloride resin (PVC), and the color of the adhesive layer being white, the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Example 1.

### Example 33

Other than the surface-protecting layer not being provided, the over-laminate film being a black high gloss vinyl chloride resin (PVC), the thickness of the film layer of the over-laminate film being 86 μm, and the color of the adhesive layer being white, the decorative sheet was produced in the same manner as in Example 14. Specifically, other than the black soft polyvinyl chloride resin solution JS1500ORG manufactured by 3M being used, the film layer including black high gloss vinyl chloride resin (PVC) was produced using a similar method to Example 1. The same adhesive layer was used as in Example 1.

### Example 34

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 85° C., the decorative sheet was produced in the same manner as in Example 14. Specifically, the same film layer including white high gloss vinyl chloride resin (PVC) and adhesive layer were used as in Example 11.

### Example 35

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 75° C., the decorative sheet was produced in the same manner as in Example 14. Specifically, the same film layer including white high gloss vinyl chloride resin (PVC) and adhesive layer were used as in Example 34.

### Example 36

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 65° C., the decorative sheet was produced in the same manner as in Example 14. Specifically, the same film layer including white high gloss vinyl chloride resin (PVC) and adhesive layer were used as in Example 34.

### Example 37

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 55° C., the decorative sheet was produced in the same manner as in Example 14. Specifically, the same film layer including white high gloss vinyl chloride resin (PVC) and adhesive layer were used as in Example 34.

### Example 38

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 45° C., the decorative sheet was produced in the same manner as in Example 14. Specifically, the same film layer including white high gloss vinyl chloride resin (PVC) and adhesive layer were used as in Example 34.

### Example 39

Other than the surface-protecting layer not being provided, the over-laminate film being a white high gloss vinyl chloride resin (PVC), the thickness of the film layer of the over-laminate film being 47 μm, the color of the adhesive layer being white, and the laminating temperature being 35° C., the decorative sheet was produced in the same manner as in Example 14. Specifically, the same film layer including white high gloss vinyl chloride resin (PVC) and adhesive layer were used as in Example 34.

### Comparative Example 1

Other than the over-laminate film being a white high gloss vinyl chloride resin (PVC), the thickness of the film layer of the over-laminate film being 86 μm, and the peak temperature of the tan δ of the adhesive layer being −22° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. Other than the adhesive solution being prepared by mixing 100 parts by mass ADH6 and 3.6 parts by mass CL3 without using the color pigment dispersion solution, the adhesive layer was produced using a similar method to Example 1. After surface-protecting material SCLSOL (manufactured by 3M) formed of polyurethane resin is coated, the surface-protecting layer was formed by drying. The thickness of the surface-protecting layer was approximately 2 μm.

### Comparative Example 2

Other than the surface-protecting layer not being provided, the over-laminate film being a white high gloss vinyl chloride resin (PVC), and the peak temperature of the tan δ of the adhesive layer being −22° C., the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Comparative Example 1.

### Comparative Example 3

Other than the surface-protecting layer not being provided, the over-laminate film being a black high gloss vinyl chloride resin (PVC), and the peak temperature of the tan δ of the adhesive layer being −22° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Comparative Example 1.

### Comparative Example 4

Other than the surface-protecting layer not being provided, the over-laminate film being a black high gloss vinyl chloride resin (PVC), the thickness of the film layer of the over-laminate film being 86 μm, and the peak temperature of the tan δ of the adhesive layer being −22° C., the decorative sheet was produced in the same manner as in Example 14. Specifically, other than the black soft polyvinyl chloride resin solution JS15000RG manufactured by 3M being used, the film layer including black high gloss vinyl chloride resin (PVC) was produced using a similar method to Example 1. The same adhesive layer was used as in Comparative Example 1.

### Comparative Example 5

Other than the surface-protecting layer not being provided, the over-laminate film being a white high gloss vinyl chloride resin (PVC), the thickness of the film layer of the over-laminate film being 100 μm, and the color of the adhesive layer being white, the decorative sheet was produced in the same manner as in Example 14. Specifically, other than the white soft polyvinyl chloride resin solution JS1000ORG manufactured by 3M being used, the film layer including white high gloss vinyl chloride resin (PVC) was produced using a similar method to Example 1. The same adhesive layer was used as in Comparative Example 1.

Table 7 to Table 15 are tables indicating production conditions of the decorative sheet, the configuration of the decorative sheet, a measurement result of the over-laminate film, and an evaluation result of sharpness in Example 14 to Example 39 and Comparative Example 1 to Comparative Example 5. Table 7 indicates Example 14 to Example 17, Table 8 indicates Example 18 to Example 21, Table 9 indicates Example 22 to Example 25, Table 10 indicates Example 26 to Example 29, Table 11 indicates Example 30 to Example 33, Table 12 indicates Example 34 to Example 36, and Table 13 indicates Example 37 to Example 39. Table 14 indicates Comparative Example 1 to Comparative Example 4, and Table 15 indicates Comparative Example 5. In the sharpness evaluation, concerning the number of stripes formed by the printed portion of the decorative sheet, it was investigated whether the produced number and the number able to be visually recognized match. When the number matches, “A” is evaluated and when the number does not match, “B” is evaluated.

TABLE 7

| | | Example 14 | Example 15 | Example 16 | Example 17 |
|---|---|---|---|---|---|
| Substrate | Material | IJ180-10 | IJ180-10 | IJ180-10 | IJ180-10 |
| Printed portion | Thickness (μm) | 21 | 21 | 21 | 21 |
| Surface- | Material | Polyurethane | None | None | None |
| protecting | Thickness (μm) | 2 | 0 | 0 | 0 |
| layer | | | | | |
| Over-laminate | Material | Acrylic resin | PVC | PVC | PVC |
| film layer | | (Transparent | (Transparent | (White high | (Transparent |
| | | high gloss) | high gloss) | gloss) | high gloss) |
| | Thickness(μm) | 50 | 50 | 70 | 50 |
| Adhesive | Color | Transparent | Transparent | Silver | Transparent |
| layer | Thickness(μm) | 30 | 30 | 30 | 30 |
| | tanδ peak | −5 | −17 | −17 | −7 |
| | temperature (° C.) | | | | |

| | | | | |
|---|---|---|---|---|
| Ra (μm) | 2.8 | 1.9 | 2.6 | 2.9 |
| Rz (μm) | 12.3 | 10.1 | 16.6 | 13.4 |
| Ra (ratio) (%) | 180 | 113 | 160 | 190 |
| Sharpness evaluation | A | A | A | A |

TABLE 8

| | | Example 18 | Example 19 | Example 20 | Example 21 |
|---|---|---|---|---|---|
| Substrate | Material | IJ180-10 | IJ180-10 | IJ180-10 | IJ180-10 |
| Printed portion | Thickness (μm) | 21 | 21 | 21 | 21 |
| Surface- | Material | None | Polyurethane | None | None |
| protecting | Thickness (μm) | 0 | 2 | 0 | 0 |
| layer | | | | | |
| Over-laminate | Material | PVC | PVC | PVC | PVC |
| film layer | | (White | (White high | (Black high | (Black high |
| | | high gloss) | gloss) | gloss) | gloss) |
| | Thickness (μm) | 50 | 50 | 50 | 86 |
| Adhesive | Color | Gray | Gray | Gray | Gray |
| layer | Thickness (μm) | 30 | 30 | 30 | 30 |
| | tanδ peak | −7 | −7 | −7 | −7 |
| | temperature (° C.) | | | | |

| | | | | |
|---|---|---|---|---|
| Ra (μm) | 2.1 | 1.7 | 2.2 | 1.6 |
| Rz (μm) | 12.0 | 11.9 | 13.7 | 10.4 |
| Ra (ratio) (%) | 200 | 113 | 214 | 129 |
| Sharpness evaluation | A | A | A | A |

TABLE 9

| | | Example 22 | Example 23 | Example 24 | Example 25 |
|---|---|---|---|---|---|
| Substrate | Material | IJ180-10 | IJ180-10 | IJ180-10 | IJ180-10 |
| Printed portion | Thickness (μm) | 21 | 21 | 21 | 21 |
| Surface- | Material | Polyurethane | None | None | None |
| protecting | Thickness (μm) | 2 | 0 | 0 | 0 |
| layer | | | | | |
| Over-laminate | Material | PVC | PVC | PVC | PVC |
| film layer | | (White high | (White high | (Black high | (Black high |
| | | gloss) | gloss) | gloss) | gloss) |
| | Thickness (μm) | 50 | 50 | 50 | 86 |
| Adhesive | Color | Transparent | Transparent | Transparent | Transparent |
| layer | Thickness (μm) | 30 | 30 | 30 | 30 |
| | tanδ peak | −14 | −14 | −14 | −14 |
| | temperature (° C.) | | | | |

| | | | | |
|---|---|---|---|---|
| Ra (μm) | 2.3 | 2.4 | 2.6 | 2.3 |
| Rz (μm) | 14.8 | 15.3 | 16.9 | 13.4 |
| Ra (ratio) (%) | 188 | 300 | 189 | 130 |
| Sharpness evaluation | A | A | A | A |

TABLE 10

| | | Example 26 | Example 27 | Example 28 | Example 29 |
|---|---|---|---|---|---|
| Substrate | Material | IJ180-10 | IJ180-10 | IJ180-10 | IJ180-10 |
| Printed portion | Thickness (μm) | 21 | 21 | 21 | 21 |
| Surface- | Material | None | Polyurethane | None | None |
| protecting | Thickness (μm) | 0 | 2 | 0 | 0 |
| layer | | | | | |
| Over-laminate | Material | PVC | PVC | PVC | PVC |
| film layer | | (White high | (White high | (Black high | (Black high |
| | | gloss) | gloss) | gloss) | gloss) |
| | Thickness (μm) | 50 | 50 | 50 | 86 |
| Adhesive | Color | Transparent | Transparent | Transparent | Transparent |
| layer | Thickness (μm) | 30 | 30 | 30 | 30 |
| | tanδ peak | −6 | −6 | −6 | −6 |
| | temperature (° C.) | | | | |

| | | | | |
|---|---|---|---|---|
| Ra (μm) | 2.2 | 2.2 | 2.6 | 2.3 |
| Rz (μm) | 13.9 | 13.7 | 16.5 | 14.1 |
| Ra (ratio) (%) | 214 | 267 | 271 | 283 |
| Sharpness evaluation | A | A | A | A |

TABLE 11

| | | Example 30 | Example 31 | Example 32 | Example 33 |
|---|---|---|---|---|---|
| Substrate | Material | IJ180-10 | IJ180-10 | IJ180-10 | IJ180-10 |
| Printed portion | Thickness (μm) | 21 | 21 | 21 | 21 |
| Surface- | Material | None | Polyurethane | None | None |
| protecting | Thickness (μm) | 0 | 2 | 0 | 0 |
| layer | | | | | |
| Over-laminate | Material | PVC | PVC | PVC | PVC |
| film layer | | (White high | (White high | (Black high | (Black high |
| | | gloss) | gloss) | gloss) | gloss) |
| | Thickness (μm) | 50 | 50 | 50 | 86 |
| Adhesive | Color | White | White | White | White |
| layer | Thickness (μm) | 30 | 30 | 30 | 30 |
| | tanδ peak | −5 | −5 | −5 | −5 |
| | temperature (° C.) | | | | |

| | | | | |
|---|---|---|---|---|
| Ra (μm) | 3.0 | 3.2 | 3.3 | 3.1 |
| Rz (μm) | 18.9 | 18.9 | 20.0 | 18.7 |
| Ra (ratio) (%) | 329 | 300 | 313 | 520 |
| Sharpness evaluation | A | A | A | A |

TABLE 12

| | | Example 34 | Example 35 | Example 36 |
|---|---|---|---|---|
| Substrate | Material | IJ180-10 | IJ180-10 | IJ180-10 |
| Printed | Thickness | 21 | 21 | 21 |
| portion | (μm) | | | |
| Surface- | Material | None | None | None |
| protecting | Thickness | 0 | 0 | 0 |
| layer | (μm) | | | |
| Over-laminate | Material | PVC | PVC | PVC |
| film layer | | (White high | (White high | (White high |
| | | gloss) | gloss) | gloss) |
| | Thickness | 47 | 47 | 47 |
| | (μm) | | | |
| Adhesive | Color | White | White | White |
| layer | Thickness | 30 | 30 | 30 |
| | (μm) | | | |
| | tanδ | −5 | −5 | −5 |
| | peak | | | |
| | temperature | | | |
| | (° C.) | | | |

| | | | |
|---|---|---|---|
| Laminating temperature (° C.) | 85 | 75 | 65 |
| Ra (μm) | 2.7 | 2.9 | 3.2 |
| Rz (μm) | 18.9 | 18.9 | 18.8 |
| Ra (ratio) (%) | 286 | 314 | 357 |
| Sharpness evaluation | A | A | A |

TABLE 13

| | | Example 37 | Example 38 | Example 39 |
|---|---|---|---|---|
| Substrate | Material | IJ180-10 | IJ180-10 | IJ180-10 |
| Printed | Thickness | 21 | 21 | 21 |
| portion | (μm) | | | |
| Surface- | Material | None | None | None |
| protecting | Thickness | 0 | 0 | 0 |
| layer | (μm) | | | |
| Over-laminate | Material | PVC | PVC | PVC |
| film layer | | (White high | (White high | (White high |
| | | gloss) | gloss) | gloss) |
| | Thickness | 47 | 47 | 47 |
| | (μm) | | | |
| Adhesive | Color | White | White | White |
| layer | Thickness | 30 | 30 | 30 |
| | (μm) | | | |
| | tanδ | −5 | −5 | −5 |
| | peak | | | |
| | temperature | | | |
| | (° C.) | | | |

| | | | |
|---|---|---|---|
| Laminating temperature (° C.) | 55 | 45 | 35 |
| Ra (μm) | 2.8 | 2.5 | 2.1 |
| Rz (μm) | 16.8 | 15.9 | 12.1 |
| Ra (ratio) (%) | 300 | 257 | 200 |
| Sharpness evaluation | A | A | A |

TABLE 14

| | | Comparative | Comparative | Comparative | Comparative |
|---|---|---|---|---|---|
| | | Example 1 | Example 2 | Example 3 | Example 4 |
| Substrate | Material | IJ180-10 | IJ180-10 | IJ180-10 | IJ180-10 |
| Printed portion | Thickness (μm) | 21 | 21 | 21 | 21 |
| Surface- | Material | Polyurethane | None | None | None |
| protecting | Thickness (μm) | 2 | 0 | 0 | 0 |
| layer | | | | | |
| Over-laminate | Material | PVC | PVC | PVC | PVC |
| film layer | | (White high | (White high | (Black high | (Black high |
| | | gloss) | gloss) | gloss) | gloss) |
| | Thickness (μm) | 50 | 50 | 50 | 86 |
| Adhesive | Color | Transparent | Transparent | Transparent | Transparent |
| layer | Thickness (μm) | 30 | 30 | 30 | 30 |
| | tanδ peak | −22 | −22 | −22 | −22 |
| | temperature (° C.) | | | | |

| | | | | |
|---|---|---|---|---|
| Ra (μm) | 2.2 | 1.9 | 2.1 | 1.6 |
| Rz (μm) | 10.6 | 11 | 11.8 | 8.9 |
| Ra (ratio) (%) | 83 | 46 | 91 | 60 |
| Sharpness evaluation | B | B | B | B |

TABLE 15

| | | Comparative Example 5 |
|---|---|---|
| Substrate | Material | IJ180-10 |
| Printed | Thickness | 21 |
| portion | (μm) | |
| Surface- | Material | None |
| protecting | Thickness | 0 |
| layer | (μm) | |
| Over-laminate | Material | PVC |
| film layer | | (White high gloss) |
| | Thickness | 100 |
| | (μm) | |
| Adhesive | Color | White |
| layer | Thickness | 30 |
| | (μm) | |
| | tanδ | −5 |
| | peak | |
| | temperature | |
| | (° C.) | |

| | |
|---|---|
| Ra (μm) | 1.1 |
| Rz (μm) | 5.0 |
| Ra (ratio) (%) | 57 |
| Sharpness evaluation | B |

From the results of Example 14 to Example 39 and Comparative Example 1 to Comparative Example 5 in Table 7 to Table 15, sharpness of the over-laminate film according to Example 14 to Example 39 was favorable, and it was possible to evaluate that the over-laminate film had the three-dimensional shape following the three-dimensional shape of the printed portion. Meanwhile, it cannot be said that sharpness of the over-laminate film according to Comparative Example 1 to Comparative Example 5 was favorable, and it was not possible to evaluate that the over-laminate film had the three-dimensional shape following the three-dimensional shape of the printed portion.

Specifically, for example, in Comparative Example 1 to Comparative Example 5, the peak temperature of the tan δ of the adhesive layer was −22° C., a temperature lower than −20° C., and as a result, evaluation of sharpness is indicated as “B”. In Comparative Example 1 to Comparative Example 5, the thickness of the over-laminate film was 100 μm, and as a result, evaluation of sharpness was indicated as “B”. That is, when the peak temperature of the tan δ of the adhesive layer is lower than −20° C., or when the thickness of the over-laminate film is 100 μm, concerning the number of stripes formed by the printed portion of at least the decorative sheet, it is indicated that the produced number and the number able to be visually recognized do not match and sharpness deteriorates. It was indicated that the surface roughness change ratio Ra (ratio) was less than 100% and the over-laminate film did not have the three-dimensional shape following the three-dimensional shape of the printed portion.

From the results in Example 34 to Example 39, in particular, when the laminating temperature is in a temperature range of 35° C. to 85° C., evaluation of sharpness was indicated as “A”. That is, the over-laminate film was indicated to have the three-dimensional shape following the three-dimensional shape of the printed portion.

### REFERENCE SIGNS LIST

1A, 1B, 1C, 1D Decorative sheet
10 Base material
10A Printed region
10B Peripheral region
10P Surface
20A, 20B, 20C, 20D Printed portion
22 First printed layer
23 Second printed layer
30 Over-laminate film
40 Surface-protecting layer

1. A decorative sheet comprising:
a base material;
a three-dimensional shape printed portion provided on the base material and including ultraviolet light curing ink; and
an over-laminate film laminated on the base material and the printed portion, the over-laminate film including a film layer and an adhesive layer and having a three-dimensional shape following the three-dimensional shape of the printed portion.

2. The decorative sheet according to claim 1, wherein a thickness of at least one part of the printed portion is 7 μm or greater.

3. The decorative sheet according to claim 1, wherein a thickness of the film layer is 90 μm or less.

4. The decorative sheet according to claim 1, wherein when a surface roughness of the over-laminate film before being laminated on the base material and the printed portion is set as Ra (0), and a surface roughness of the over-laminate film laminated on the base material and the printed portion is set as Ra, a surface roughness change ratio Ra (ratio) of the over-laminate film represented by Formula (1) is 110% or greater;
Wherein Formula (1) is:
Ra(ratio)(%)=(Ra−Ra(0))/Ra(0)×100.

5. The decorative sheet according to claim 1, wherein a surface roughness Rz of the over-laminate film is approximately 10 μm or greater.

6. The decorative sheet according to claim 1, wherein the film layer is transparent.

7. The decorative sheet according to claim 1, wherein the film layer is colored.

8. The decorative sheet according to claim 1, wherein a peak temperature of a coefficient of loss (tan δ) of the adhesive layer is −20° C. or higher.

9. The decorative sheet according to claim 1, wherein the printed portion has a plurality of printed layers.

10. The decorative sheet according to claim 9, wherein the plurality of printed layers include a first printed layer and a second printed layer having substantially the same planar pattern as the first printed layer and disposed on the first printed layer.

11. The decorative sheet according to claim 9, wherein the plurality of printed layers include at least a color layer having low transparency and a stereoscopic form layer with higher transparency than the transparency of the color layer.

12. The decorative sheet according to claim 9, wherein the plurality of printed layers include the first printed layer and the second printed layer having a different planar pattern from the first printed layer and disposed on the first printed layer.

13. The decorative sheet according to claim 1, further comprising a surface-protecting layer on an outermost surface of the over-laminate film.

14. A production method of a decorative sheet, the method comprising the steps of:
carrying out ultraviolet light curing inkjet printing on a base material and forming a three-dimensional shape printed portion; and
laminating an over-laminate film on the base material and the printed portion so that an adhesive layer of the over-laminate film faces the base material and printed portion side, the over-laminate film being formed in a three-dimensional shape following the three-dimensional shape of the printed portion.

15. The production method of a decorative sheet according to claim 14, wherein in the lamination step, the over-laminate film is laminated in a state of being heated to 35° C. or higher and 85° C. or lower.
